(19) United States
(12) Patent Application Publication
(10) Pub. No.: US 2025/0365465 A1
(43) Pub. Date: Nov. 27, 2025

(54) IMAGE DISPLAY METHOD, IMAGE DISPLAY APPARATUS, IMAGE DISPLAY DEVICE, ELECTRONIC DEVICE, AND STORAGE MEDIUM

(71) Applicant: BOE TECHNOLOGY GROUP CO., LTD., Beijing (CN)

(72) Inventors: Yue LI, Beijing (CN); Guangwei HUANG, Beijing (CN); Xiao CHU, Beijing (CN)

(21) Appl. No.: 18/995,495

(22) PCT Filed: Jan. 19, 2024
(86) PCT No.: PCT/CN2024/073329

§ 371 Date: Jan. 16, 2025

(51) Int. Cl. H04N 21/43; G06F 3/14

(52) U.S. Cl. CPC H04N 21/43078; G06F 3/1407; G06F 3/1423; H04N 21/43076

(57) ABSTRACT

An image display method, an image display apparatus, an image display device, an electronic device and a storage medium are provided, which may be applied in a field of a display technology. The image display method includes: acquiring an original resolution of an original image and a target resolution of a display apparatus; generating a target image according to the original image, the original resolution and the target resolution; and sending the target image to the display apparatus, so that the display apparatus displays the target image.

### TECHNICAL FIELD

The present disclosure relates to a field of a display technology, and in particular to an image display method, an image display apparatus, an image display device, an electronic device, and a storage medium.

### BACKGROUND

In application scenarios such as commercial display or information distribution, there is a need to display an original image such as a poster on different display apparatuses. However, when the original image is displayed on a display apparatus, if a resolution of the original image is inconsistent with a resolution of the display apparatus, there may be problems such as black edge, image stretching and distortion, or unclear display, which causes a poor visual experience for a user.

### SUMMARY

In view of this, the present disclosure provides an image display method, an image display apparatus, an image display device, an electronic device, and a storage medium.

According to an aspect of the present disclosure, an image display method is provided, including: acquiring an original resolution of an original image and a target resolution of a display apparatus; generating a target image according to the original image, the original resolution and the target resolution; and sending the target image to the display apparatus, so that the display apparatus displays the target image.

For example, the original resolution includes an original pixel width and an original pixel height, and the target resolution includes a target pixel width and a target pixel height; and the generating a target image according to the original image, the original resolution and the target resolution includes: determining a first height ratio of the target pixel height to the original pixel height; determining a first width ratio of the target pixel width to the original pixel width; determining an overlapping resolution according to the first height ratio, the first width ratio, the original resolution and the target resolution; determining a difference value according to a ratio of the overlapping resolution to the target resolution; and generating the target image according to the difference value, the original image and the target resolution.

For example, the determining an overlapping resolution according to the first height ratio, the first width ratio, the original resolution and the target resolution includes: in a case that the first height ratio is less than or equal to the first width ratio, determining the target pixel height as a height of the overlapping resolution; and determining a width of the overlapping resolution according to the height of the overlapping resolution, the original pixel height and the original pixel width.

For example, the determining an overlapping resolution according to the first height ratio, the first width ratio, the original resolution and the target resolution further includes: in a case that the first height ratio is greater than the first width ratio, determining the target pixel width as the width of the overlapping resolution; and determining the height of the overlapping resolution according to the width of the overlapping resolution, the original pixel width and the original pixel height.

For example, the generating the target image according to the difference value, the original image and the target resolution includes: in a case that the difference value is less than a preset threshold, determining a target region in the original image, where the target region contains a target element; generating a foreground image according to the target region and the original image; generating a background image according to the target region, the original image and the target resolution; stitching the background image and the foreground image to obtain a rearranged image; and adjusting a resolution of the rearranged image according to the target resolution and the rearranged image, so as to generate the target image.

For example, the generating a background image according to the target region, the original image and the target resolution includes: inputting the original image and a pixel position corresponding to the target region into an image generation model to obtain an initial background image, where a resolution of the initial background image is equal to the original resolution; down-sampling the initial background image at a first preset multiple to obtain a low-resolution background image; determining a first conversion resolution according to the target resolution, a width of the low-resolution background image and a height of the low-resolution background image; and inputting the low-resolution background image and the first conversion resolution into the image generation model to generate the background image, where a resolution of the background image is the first conversion resolution.

For example, the determining a first conversion resolution according to the target resolution, a width of the low-resolution background image and a height of the low-resolution background image includes: determining a second width ratio of the target pixel width to the width of the low-resolution background image; determining a second height ratio of the target pixel height to the height of the low-resolution background image; determining the height of the low-resolution background image as a height of the first conversion resolution in a case that the second height ratio is greater than or equal to the second width ratio; and determining a width of the first conversion resolution according to the height of the first conversion resolution and a ratio of the target pixel width to the target pixel height.

For example, the determining a first conversion resolution according to the target resolution, a width of the low-resolution background image and a height of the low-resolution background image further includes: determining the width of the low-resolution background image as the width of the first conversion resolution in a case that the second height ratio is less than the second width ratio; and determining the height of the first conversion resolution according to the width of the first conversion resolution and a ratio of the target pixel height to the target pixel width.

For example, the generating a target image according to the original image, the original resolution and the target resolution includes: down-sampling the original image at a second preset multiple to obtain a low-resolution image; determining a second conversion resolution according to the target resolution, a width of the low-resolution image and a height of the low-resolution image; inputting the down-sampled original image and the second conversion resolution into an image generation model to generate an intermediate conversion image, where a resolution of the intermediate conversion image is the second conversion resolution; and adjusting the resolution of the intermediate conversion image according to the target resolution and the intermediate conversion image, so as to generate the target image.

For example, the determining a second conversion resolution according to the target resolution, a width of the low-resolution image and a height of the low-resolution image includes: determining a third width ratio of the target pixel width to the width of the low-resolution image; determining a third height ratio of the target pixel height to the height of the low-resolution image; determining the height of the low-resolution image as a height of the second conversion resolution in a case that the third height ratio is greater than or equal to the third width ratio; and determining a width of the second conversion resolution according to the height of the second conversion resolution and a ratio of the target pixel width to the target pixel height.

For example, the determining a second conversion resolution according to the target resolution, a width of the low-resolution image and a height of the low-resolution image further includes: in a case that the third height ratio is less than the third width ratio, determining the width of the low-resolution image as the width of the second conversion resolution; and determining the height of the second conversion resolution according to the width of the second conversion resolution and a ratio of the target pixel height to the target pixel width.

For example, the inputting the low-resolution background image and the first conversion resolution into the image generation model to generate the background image includes: acquiring a first preset prompt word and a first preset model parameter; and inputting the low-resolution background image, the first preset prompt word, the first preset model parameter and the first conversion resolution into the image generation model to generate the background image.

For example, the inputting the down-sampled original image and the second conversion resolution into an image generation model to generate an intermediate conversion image includes: acquiring a second preset prompt word and a second preset model parameter; and inputting the down-sampled original image, the second preset prompt word, the second preset model parameter and the second conversion resolution into the image generation model to generate the intermediate conversion image.

For example, the generating a foreground image according to the target region and the original image includes: inputting the original image and a pixel position corresponding to the target region into an image segmentation model to generate the foreground image.

For example, the method further includes: determining the first preset model parameter, the first preset multiple, the first preset prompt word, the second preset model parameter, the second preset multiple and the second preset prompt word according to the original image and a configuration parameter from a client, where the configuration parameter is related to a generation effect and a generation speed of the image generation model.

For example, the configuration parameter includes at least one selected from: a generation style, a generation speed, a generation creativity, a text description of generated content, or the target resolution; and the first preset model parameter and the second preset model parameter each include at least one selected from: a number of pixels to expand, a degree of mask blur, an image outpainting direction, a fall-off exponent, a color variation degree parameter, a sampling method, sampling steps, a denoising strength, and a classifier free guidance scale.

According to another aspect of the present disclosure, an image display apparatus is provided, including: an acquisition module configured to acquire an original resolution of an original image and a target resolution of a display apparatus; a generation module configured to generate a target image according to the original image, the original resolution and the target resolution; and a display module configured to send the target image to the display apparatus, so that the display apparatus displays the target image.

According to another aspect of the present disclosure, an electronic device is provided, including: one or more processors; and a storage device configured to store one or more programs, where the one or more programs are configured to, when executed by the one or more processors, cause the one or more processors to perform the method described above.

According to another aspect of the present disclosure, an image display device is provided, including: the electronic device described above; and a display apparatus configured to acquire a target image from the electronic device and display the target image.

According to another aspect of the present disclosure, a computer-readable storage medium storing executable instructions thereon is provided, where the instructions are configured to, when executed by a processor, cause the processor to perform the method described above.

According to another aspect of the present disclosure, a computer program product containing a computer program is provided, where the computer program is configured to, when executed by a processor, cause the processor to perform the method described above.

It should be understood that content described in this section is not intended to identify key or important features in embodiments of the present disclosure, nor is it intended to limit the scope of the present disclosure. Other features of the present disclosure will be easily understood through the following description.

According to embodiments of the present disclosure, the original resolution of the original image and the target resolution of the display apparatus are acquired, and the target image is generated according to the original image, the original resolution and the target resolution. Specifically, the original image is expanded to the target resolution based on a difference between the original resolution and the target resolution, and the resolution of the obtained target image is the target resolution. When the target image is sent to the display apparatus for display, the display apparatus may display the target image in full screen without stretching and distortion or unclear display, so that a good visual experience is provided to the user.

### BRIEF DESCRIPTION OF THE DRAWINGS

The accompanying drawings are provided for a better understanding of the solutions and do not constitute a limitation on the present disclosure. In the accompanying drawings:

FIG. 1 schematically shows a schematic diagram of directly displaying an original image on a display apparatus;

FIG. 2 schematically shows an application scenario diagram of an image display method according to embodiments of the present disclosure;

FIG. 3 schematically shows a flowchart of an image display method according to embodiments of the present disclosure;

FIG. 4(A) schematically shows a schematic diagram of an original image according to embodiments of the present disclosure;

FIG. 4(B) schematically show a schematic diagram of a marked original image according to embodiments of the present disclosure;

FIG. 4(C) schematically shows a schematic diagram of a foreground image according to embodiments of the present disclosure;

FIG. 4(D) schematically shows a schematic diagram of an initial background image according to embodiments of the present disclosure;

FIG. 4(E) schematically shows a schematic diagram of a background image according to embodiments of the present disclosure;

FIG. 4(F) schematically shows a schematic diagram of a rearranged image according to embodiments of the present disclosure;

FIG. 5(A) schematically shows a schematic diagram of a display apparatus according to embodiments of the present disclosure;

FIG. 5(B) schematically shows a schematic diagram of directly displaying an original image on a display apparatus according to embodiments of the present disclosure;

FIG. 5(C) schematically shows a schematic diagram of displaying on a display apparatus a target image that is obtained according to the image display method provided in embodiments of the present disclosure in a case that a difference value is greater than or equal to a predetermine threshold;

FIG. 6(A) schematically shows a schematic diagram of displaying on a display apparatus a target image that is obtained according to the image display method provided in embodiments of the present disclosure in a case that a difference value is greater than or equal to a predetermine threshold;

FIG. 6(B) schematically shows a schematic diagram of a locally-enlarged original image and a locally-enlarged target image according to embodiments of the present disclosure;

FIG. 7(A) schematically shows a schematic diagram of an original image according to embodiments of the present disclosure;

FIG. 7(B) schematically shows a schematic diagram of a target image that is obtained according to the image display method provided in embodiments of the present disclosure in a case that a difference value is greater than or equal to a preset threshold;

FIG. 7(C) schematically shows a schematic diagram of an original image according to embodiments of the present disclosure;

FIG. 7(D) schematically shows a schematic diagram of a target image that is obtained according to the image display method provided in embodiments of the present disclosure in a case that a difference value is greater than or equal to a preset threshold;

FIG. 7(E) schematically shows a schematic diagram of an original image according to embodiments of the present disclosure;

FIG. 7(F) schematically shows a schematic diagram of a target image that is obtained according to the image display method provided in embodiments of the present disclosure in a case that a difference value is greater than or equal to a preset threshold;

FIG. 7(G) schematically shows a schematic diagram of an original image according to embodiments of the present disclosure;

FIG. 7(H) schematically shows a schematic diagram of a target image that is obtained according to the image display method provided in embodiments of the present disclosure in a case that a difference value is greater than or equal to a preset threshold;

FIG. 8 schematically shows a system architecture diagram for an image display method according to embodiments of the present disclosure;

FIG. 9 schematically shows a schematic diagram of a functional interface of AI image generation according to embodiments of the present disclosure;

FIG. 10 schematically shows a schematic diagram of a functional interface of intelligent image filling according to embodiments of the present disclosure;

FIG. 11 schematically shows a flowchart of an image display method according to other embodiments of the present disclosure;

FIG. 12 schematically shows a flowchart of an image display method according to still other embodiments of the present disclosure;

FIG. 13 schematically shows a structural block diagram of an image display apparatus according to embodiments of the present disclosure;

FIG. 14 schematically shows a block diagram of an electronic device suitable for implementing an image display method according to embodiments of the present disclosure; and

FIG. 15 schematically shows a schematic diagram of an image display device according to embodiments of the present disclosure.

### DETAILED DESCRIPTION OF EXAMPLES

In order to make objectives, technical solutions and advantages of the present disclosure clearer, the technical solutions in embodiments of the present disclosure will be described below clearly and comprehensively with reference to the accompanying drawings in embodiments of the present disclosure. Obviously, the described embodiments are only some embodiments rather than all embodiments of the present disclosure. Based on the described embodiments of the present disclosure, all additional embodiments obtained by those ordinary skilled in the art without carrying out inventive effort fall within the protection scope of the present disclosure. It should be noted that throughout the accompanying drawings, the same elements are represented by the same or similar reference numerals. In the following descriptions, some specific embodiments are only used for descriptive purposes and should not be construed as limiting the present disclosure, but rather examples of the embodiments of the present disclosure. When it is possible to cause confusions in the understanding of the present disclosure, conventional structures or configurations will be omitted. It should be noted that the shape and size of each component in the figures do not reflect the actual size and ratio, but just illustrate the contents of the embodiments of the present disclosure.

Unless otherwise defined, the technical or scientific terms used in embodiments of the present disclosure should have the usual meanings understood by those skilled in the art. The words “first”, “second” and the like used in embodiments of the present disclosure do not indicate any order, quantity or importance, but are merely used to distinguish different composition parts.

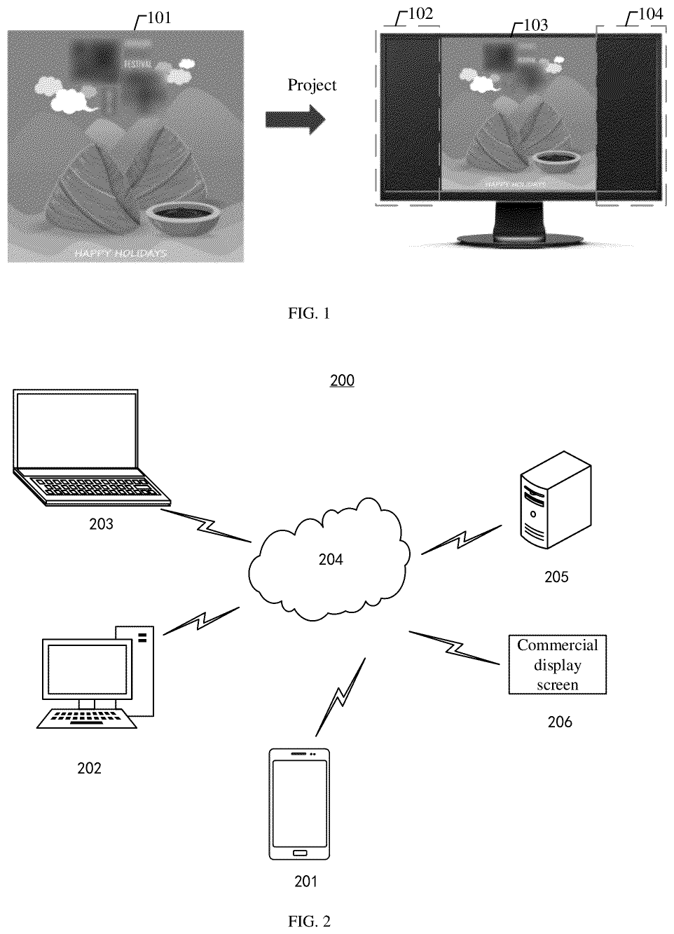

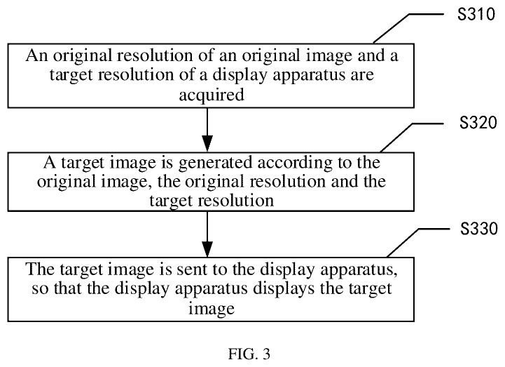

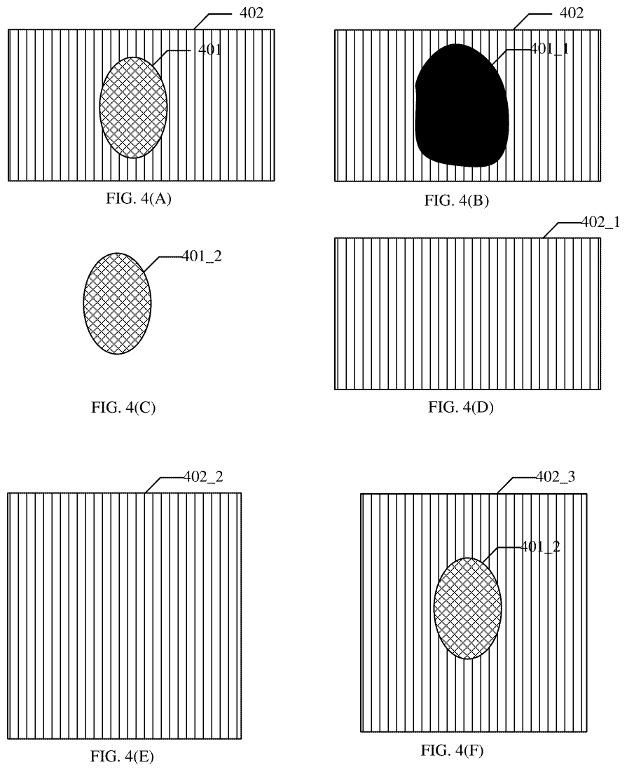

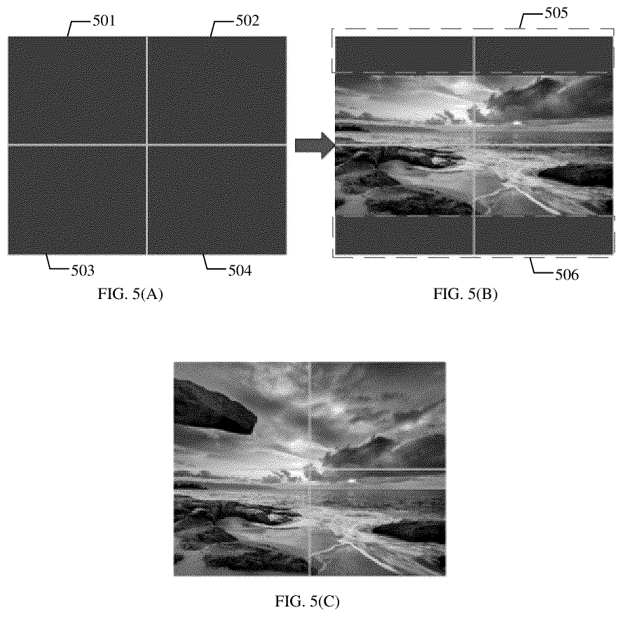

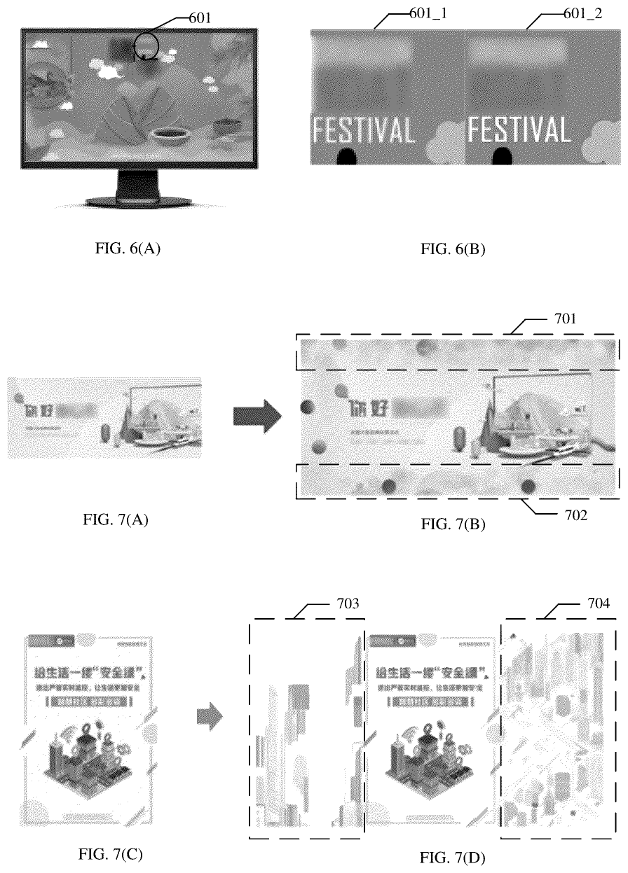

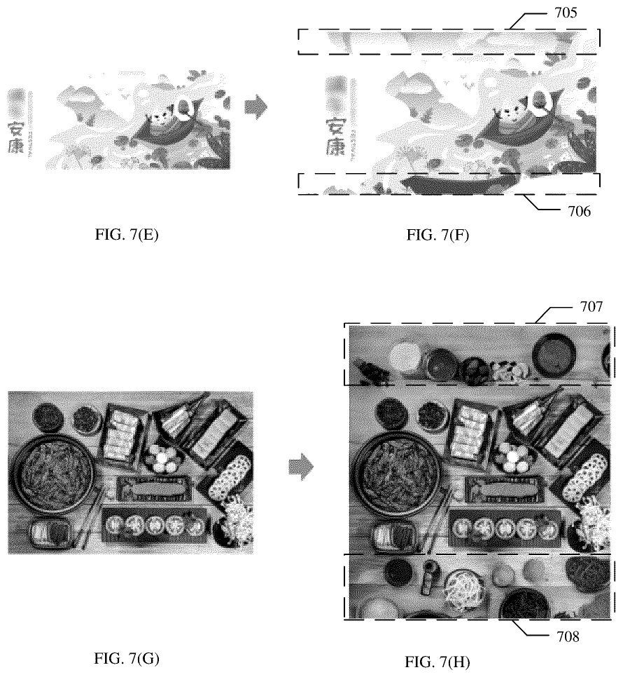

FIG. 1 schematically shows a schematic diagram of directly displaying an original image on a display apparatus.

As shown in FIG. 1, in a case that a resolution of an original image 101 is inconsistent with a resolution of a display apparatus and the original image 101 is projected onto the display apparatus, the original image 101 is displayed in a display region 103 of the display apparatus, and black edges are displayed in a display region 102 and a display region 104 of the display apparatus, which causes a poor visual experience.

Further, in the case that the resolution of the original image is inconsistent with the resolution of the display apparatus and the original image is projected onto the display apparatus, in addition to the black edges as shown in FIG. 1, there may be further problems of image stretching and distortion or unclear display, which may cause a poor visual experience to a user. If the original image is adjusted manually to be suitable for the display apparatus, the cost is high and the efficiency is low. Therefore, there is a need to provide a method of efficiently adjusting the original image, so that an adjusted original image is suitable for display on a display apparatus with an arbitrary resolution, and thus a good visual experience may be provided to the user.

Embodiments of the present disclosure provide an image display method, an image display apparatus, an image display device, an electronic device and a storage medium, which may be applied to a field of a display technology.

In embodiments of the present disclosure, an image display method is provided, including: acquiring an original resolution of an original image and a target resolution of a display apparatus; generating a target image according to the original image, the original resolution and the target resolution; and sending the target image to the display apparatus, so that the display apparatus displays the target image.

FIG. 2 schematically shows an application scenario diagram of an image display method according to embodiments of the present disclosure.

As shown in FIG. 2, an application scenario 200 according to such embodiments may include a first terminal device 201, a second terminal device 202, a third terminal device 203, a network 204, a server 205 and a commercial display screen 206. The network 204 is a medium for providing a communication link between the first terminal device 201, the second terminal device 202, the third terminal device 203, the server 205 and the commercial display screen 206. The network 204 may include various connection types, such as wired and/or wireless communication links, fiber optic cables, or the like.

At least one of the first terminal device 201, the second terminal device 202 or the third terminal device 203 may be used by the user to interact with the server 205 through the network 204 to receive or send messages, etc. The first terminal device 201, the second terminal device 202 and the third terminal device 203 may be installed with various communication client applications, such as shopping applications, web browser applications, search applications, instant messaging tools, email clients and/or social platform software, web management applications for information distribution system, or the like (only for example).

The first terminal device 201, the second terminal device 202 and the third terminal device 203 may be various electronic devices having display screens and supporting web browsing, including but not limited to smart phones, tablet computers, laptop computers, and desktop computers, etc.

The server 205 may be a server providing various services. For example, the server 205 may be a backstage management server that provides a support for a web management application for information distribution system operated by the user using the first terminal device 201, the second terminal device 202 and the third terminal device 203. The backstage management server may analyze and process received data such as a user request, and then feed back a processing result to the terminal device or display the processing result on the commercial display screen 206.

The commercial display screen 206 may be a single display screen, a spliced screen, a curved screen, or the like, which is used to display a target file or a target image that is generated by the server 205 after the received data such as the user request is processed.

For example, the network 204 may be a communication link with an information distribution box as an intermediate medium. The information distribution box may be a hardware terminal device that may be connected to an advertising machine, the commercial display screen 206 or other display hardware devices, and in that an information distribution terminal software may be installed. The web management application for information distribution system may be operated by the user using the first terminal device 201, the second terminal device 202 and the third terminal device 203 to generate a file processing request or an image display request, and the file processing request or the image display request may be sent to the server 205 through the information distribution box. The server 205 may receive data such as the file processing request or the image display request sent by the user through the information distribution box, analyze and process the data such as the file processing request or the image display request sent by the user, feed back a processing result (for example, a target file or a target image generated according to the user request) to the terminal device, and send the target file or the target image to the commercial display screen 206 through the information distribution box, so that the commercial display screen 206 displays the target file or the target image.

It should be noted that the image display method provided in embodiments of the present disclosure may be generally performed by the server 205. Accordingly, an image display apparatus provided in embodiments of the present disclosure may be generally provided in the server 205. The image display method provided in embodiments of the present disclosure may also be performed by a server or server cluster different from the server 205 and capable of communicating with the first terminal device 201, the second terminal device 202, the third terminal device 203 and/or the server 205. Accordingly, the image display apparatus provided in embodiments of the present disclosure may also be provided in a server or server cluster different from the server 205 and capable of communicating with the first terminal device 201, the second terminal device 202, the third terminal device 203 and/or the server 205.

It should be understood that the number of terminal devices, network and server shown in FIG. 2 are merely schematic. According to implementation needs, any number of terminal devices, networks and servers may be provided.

FIG. 3 schematically shows a flowchart of an image display method according to embodiments of the present disclosure.

As shown in FIG. 3, the image display method in such embodiments includes operation S310 to operation S330.

In operation S310, an original resolution of an original image and a target resolution of a display apparatus are acquired.

According to embodiments of the present disclosure, the display apparatus may include at least one display screen.

For example, the display apparatus may be a single display screen such as a digital signage, or may be a spliced screen formed by four single display screens having the same resolution.

In operation S320, a target image is generated according to the original image, the original resolution and the target resolution.

According to embodiments of the present disclosure, it is possible to firstly determine a difference in an aspect ratio between the original image and the target image according to the original resolution and the target resolution, and then expand the original image to the target resolution to obtain the target image according to the difference in the aspect ratio by using different strategies, so that the target image is suitable for display on the display apparatus.

According to embodiments of the present disclosure, a resolution of the target image is the target resolution.

In operation S330, the target image is sent to the display apparatus, so that the display apparatus displays the target image.

According to embodiments of the present disclosure, the resolution of the target image is the same as the resolution of the display apparatus, and both are the target resolution. Therefore, the display apparatus may display the target image in full screen without problems of stretching and distortion or unclear display.

According to embodiments of the present disclosure, the original resolution of the original image and the target resolution of the display apparatus are acquired, and the target image is generated according to the original image, the original resolution and the target resolution. Specifically, the original image is expanded to the target resolution based on a difference between the original resolution and the target resolution, and the resolution of the obtained target image is the target resolution. When the target image is sent to the display apparatus for display, the display apparatus may display the target image in full screen without stretching and distortion or unclear display, so that a good visual experience is provided to the user.

According to embodiments of the present disclosure, the original resolution includes an original pixel width and an original pixel height, and the target resolution includes a target pixel width and a target pixel height. As to operation S320 as shown in FIG. 3, generating the target image according to the original image, the original resolution and the target resolution may include the following steps: determining a first height ratio of the target pixel height to the original pixel height; determining a first width ratio of the target pixel width to the original pixel width; determining an overlapping resolution according to the first height ratio, the first width ratio, the original resolution and the target resolution; determining a difference value according to a ratio of the overlapping resolution to the target resolution; and generating the target image according to the difference value, the original image and the target resolution.

According to embodiments of the present disclosure, the overlapping resolution represents a maximum resolution that has the same aspect ratio as the original resolution and overlaps with the target resolution in a pixel width direction or pixel height direction. The overlapping resolution represents a maximum resolution to which the original image may be expanded without generating content when the original image is expanded to the target resolution.

According to embodiments of the present disclosure, the first height ratio may be a ratio of the target pixel height to the original pixel height, the first width ratio may be a ratio of the target pixel width to the original pixel width, and the difference value may be a ratio of the overlapping resolution to the target resolution.

For example, the first width ratio may be obtained according to Equation (1), and the first height ratio may be obtained according to Equation (2).

$$First width ratio = \frac{{w}_{d}}{{w}_{o}} \qquad ( 1 )$$

$$First height ratio = \frac{{h}_{d}}{{h}_{o}} \qquad ( 2 )$$

where w_{d} represents the target pixel width, wₒ represents the original pixel width, h_{d} represents the target pixel height, and hₒ represents the original pixel height.

According to embodiments of the present disclosure, determining the overlapping resolution according to the first height ratio, the first width ratio, the original resolution and the target resolution includes: in a case that the first height ratio is less than or equal to the first width ratio, determining the target pixel height as a height of the overlapping resolution; and determining a width of the overlapping resolution according to the height of the overlapping resolution, the original pixel height and the original pixel width.

According to embodiments of the present disclosure, determining the width of the overlapping resolution according to the height of the overlapping resolution, the original pixel height and the original pixel width includes: determining the width of the overlapping resolution according to the original pixel width and a ratio of the height of the overlapping resolution to the original pixel height.

According to embodiments of the present disclosure, the width of the overlapping resolution may be obtained by multiplying the ratio of the height of the overlapping resolution to the original pixel height by the original pixel width. The overlapping resolution may be obtained by multiplying the height of the overlapping resolution by the width of the overlapping resolution.

For example, in a case of

$$\frac{{w}_{d}}{{w}_{o}} \geq \frac{{h}_{d}}{{h}_{o}} ,$$

the height of the overlapping resolution may be determined according to Equation (3), the width of the overlapping resolution may be determined according to Equation (4), and the difference value may be obtained according to Equation (5).

$${h}_{o}^{′} = {h}_{d} \qquad ( 3 )$$

$${w}_{o}^{′} = {w}_{o} * {h}_{o}^{′} / {h}_{o} \qquad ( 4 )$$

$$Δ = \frac{{w}_{o}^{′} * {h}_{o}^{′}}{{w}_{d} * {h}_{d}} \qquad ( 5 )$$

where,

$${h}_{o}^{′}$$

represents the height of the overlapping resolution,

$${w}_{o}^{′}$$

represents the width of the overlapping resolution, and Δ represents the difference value.

According to embodiments of the present disclosure, in the case that the first height ratio is less than or equal to the first width ratio, the target pixel height is determined as the height of the overlapping resolution, and the width of the overlapping resolution is determined according to the height of the overlapping resolution, the original pixel height and the original pixel width. Thus, the overlapping resolution represents a maximum resolution to which the original image may be expanded without generating content when the original image is expanded to the target resolution. Subsequently, a difference value is determined according to the ratio of the overlapping resolution to the target resolution. The difference value represents an amount of data of a filling content that needs to be generated when the original image that has been expanded to the overlapping resolution is further expanded to the target resolution.

According to embodiments of the present disclosure, determining the overlapping resolution according to the first height ratio, the first width ratio, the original resolution and the target resolution further includes: in a case that the first height ratio is greater than the first width ratio, determining the target pixel width as the width of the overlapping resolution; and determining the height of the overlapping resolution according to the width of the overlapping resolution, the original pixel width and the original pixel height.

According to embodiments of the present disclosure, determining the height of the overlapping resolution according to the width of the overlapping resolution, the original pixel width and the original pixel height includes: determining the height of the overlapping resolution according to the original pixel height and the ratio of the width of the overlapping resolution to the original pixel width.

According to embodiments of the present disclosure, the height of the overlapping resolution may be obtained by multiplying the ratio of the width of the overlapping resolution to the original pixel width by the original pixel height.

For example, in a case of

$$\frac{{w}_{d}}{{w}_{o}} > \frac{{h}_{d}}{{h}_{o}} ,$$

the height of the overlapping resolution may be determined according to Equation (6), the width of the overlapping resolution may be determined according to Equation (7), and the difference value may be obtained according to Equation (8).

$${w}_{o}^{′} = {w}_{d} \qquad ( 6 )$$

$${h}_{o}^{′} = {h}_{o} * {w}_{o}^{′} / {w}_{o} \qquad ( 7 )$$

$$Δ = \frac{{w}_{o}^{′} * {h}_{o}^{′}}{{w}_{d} * {h}_{d}} \qquad ( 8 )$$

According to embodiments of the present disclosure, in the case that the first height ratio is greater than the first width ratio, the target pixel width is determined as the width of the overlapping resolution, and the height of the overlapping resolution is determined according to the width of the overlapping resolution, the original pixel width and the original pixel height. Thus, the overlapping resolution represents a maximum resolution to which the original image may be expanded without generating content when the original image is expanded to the target resolution. Subsequently, the difference value is determined according to the ratio of the overlapping resolution to the target resolution. The difference value represents an amount of data of a filling content that needs to be generated when the original image that has been expanded to the overlapping resolution is further expanded to the target resolution.

According to embodiments of the present disclosure, when the amount of data of a filling content that needs to be generated is large, the difference value is small, for example, the aspect ratio may be expanded from 9:16 to 16:9. In this case, if a background expansion is directly performed on the original image by using an image generation model, an effect of the generated target image may be uncontrollable, and the visual experience of the user may be poor. Further, a large-scale expanded generation may cause an unattractive layout in a scenario of poster. Therefore, in a comprehensive consideration of a technology implementation and a product requirement, it is possible to provide a preset threshold to determine a content rearrangement in scenarios of advertisement, poster, etc. where a large amount of content needs to be generated.

According to embodiments of the present disclosure, generating the target image according to the difference value, the original image and the target resolution may include: in a case that the difference value is less than a preset threshold, determining a target region in the original image, where the target region contains a target element; generating a foreground image according to the target region and the original image; generating a background image according to the target region, the original image and the target resolution; stitching the background image and the foreground image to obtain a rearranged image; and adjusting a resolution of the rearranged image according to the target resolution and the rearranged image, so as to generate the target image.

In the case that the difference value is less than the preset threshold, it means a large difference in the aspect ratio between the original resolution of the original image and the target resolution, and it is required to generate a large amount of filling content.

The preset threshold may be selected according to an actual situation and is not limited here. For example, the preset threshold may be 0.5, 0.6 or 0.7, etc.

According to embodiments of the present disclosure, the foreground image contains the target element, and the background image does not contain the target element.

According to embodiments of the present disclosure, the target element may be a target product in a target promotion. For example, the target element may be a target advertised product in an advertising promotion.

The resolution of the background image has the same aspect ratio as the target resolution, and the resolution of the background image is less than the target resolution. It is possible to generate one or two or more background images.

In a case that two or more background images are generated, it is possible to display a plurality of background images at a client, obtain a background image selected at the client in response to a selection operation at the client, and then perform subsequent operations of stitching and resolution adjustment on the background image selected at the client, so as to achieve a deeper interaction with the user and avoid the user waiting for too long to have a poor experience in a process of generating the target image. Therefore, such an interaction design may further improve a user satisfaction.

It is possible to obtain a marked original image in response to a marking operation at the client, and then determine the target region in the original image according to the marked original image.

According to embodiments of the present disclosure, stitching the background image and the foreground image to obtain the rearranged image includes: superimposing the foreground image and the background image to obtain a superimposed image; up-sampling or down-sampling the background image to obtain an adjusted background image in a case that a proportion of the foreground image in the superimposed image is inconsistent with a proportion of the foreground image in the original image; and superimposing the adjusted background image and the foreground image to obtain the rearranged image. In a case that the proportion of the foreground image in the superimposed image is consistent with the proportion of the foreground image in the original image, the superimposed image is determined as the rearranged image.

For example, in a case that the proportion of the foreground image in the original image is greater than the proportion of the foreground image in the superimposed image, the background image may be down-sampled to obtain an adjusted background image. In a case that the proportion of the foreground image in the original image is less than the proportion of the foreground image in the superimposed image, the background image may be up-sampled to obtain an adjusted background image.

For example, the target element contained in the foreground image may be a beverage, and the background image may be a beach. In a case that a proportion of the foreground image in the original image has a large difference from a proportion of the background image in the original image, the difference value between the original image and the target image is less than the preset threshold and the display apparatus is a spliced screen, it is possible to firstly determine the target region in the original image, where the target region contains the target element, i.e., the beverage. Then, the foreground image may be generated according to the target region and the original image, where the foreground image contains the beverage. The background image may be generated according to the target region, the original image and the target resolution, where the background image contains the beach without the beverage.

Then, the foreground image and the background image may be superimposed to obtain the superimposed image. In a case that a proportion of the beverage of the foreground image in the superimposed image is inconsistent with a proportion of the beverage of the foreground image in the original image, the background image may be up-sampled or down-sampled to obtain an adjusted background image, and then the adjusted background image may be superimposed with the foreground image to obtain the rearranged image. In a case that the proportion of the beverage of the foreground image in the superimposed image is consistent with the proportion of the beverage of the foreground image in the original image, the superimposed image may be determined as the rearranged image. Then, the resolution of the rearranged image may be adjusted according to the target resolution and the rearranged image, so as to generate the target image. The target image may be sent to the spliced screen so that the spliced screen displays the target image.

According to embodiments of the present disclosure, in the case that the proportion of the foreground image in the superimposed image is inconsistent with the proportion of the foreground image in the original image, the background image is up-sampled or down-sampled to obtain an adjusted background image, and the adjusted background image is then superimposed with the foreground image to obtain a rearranged image. The rearranged image may be obtained by only adjusting the background image without adjusting the foreground image, which may ensure that content details of the target element in the rearranged image may not be lost or deformed.

It is possible to input the target resolution and the rearranged image into an image super-resolution model, and adjust the resolution of the rearranged image to the target resolution by using the image super-resolution model, so as to obtain the target image.

According to embodiments of the present disclosure, the image super-resolution model may be selected according to an actual situation and is not limited here. For example, the image super-resolution model may be a blind image super-resolution model (Real-ESRGAN, Enhanced Super-Resolution GAN).

According to embodiments of the present disclosure, the target image is obtained by adjusting the resolution of the rearranged image to the target resolution using the image super-resolution model, so that a super-resolution target image close to the original image and having high contrast and high clarity may be obtained simply and quickly.

According to embodiments of the present disclosure, in the case that the difference value is less than the preset threshold, it means that a large amount of filling content needs to be generated when the original image is expanded to the target resolution. Therefore, it is possible to firstly determine a target region in the original image, and generate a foreground image containing a target element according to the target region and the original image to ensure that the target element in the foreground image remains unchanged. Then, a background image may be generated according to the target region, the original image and the target resolution, so that the target element in the original image is removed, and a background image of which the resolution has the same aspect ratio as the target resolution is generated on the basis of the background region in the original image. Then, the background image and the foreground image may be stitched together to obtain a rearranged image, which includes many details of the target element and of which the resolution has the same aspect ratio as the target image. Then, the resolution of the rearranged image may be adjusted according to the target resolution and the rearranged image, so that the resolution of the rearranged image may be improved to the target resolution quickly, and the target image may be generated quickly.

According to embodiments of the present disclosure, before the generation of the foreground image, a mask matrix may be generated according to the original image and the target region, so that a pixel position of the target region in the original image may be recorded in the mask matrix. A size of the mask matrix is the same as the original resolution. The pixel position of the target region may be represented by 1, and a pixel position of the background may be represented by 0.

According to embodiments of the present disclosure, generating the foreground image according to the target region and the original image includes: inputting the original image and a pixel position corresponding to the target region into an image segmentation model to generate the foreground image.

According to embodiments of the present disclosure, inputting the original image and the pixel position corresponding to the target region into the image segmentation model to generate the foreground image includes: inputting the original image and the mask matrix into the image segmentation model to generate the foreground image.

The image segmentation model may be selected according to an actual situation and is not limited here. For example, the image segmentation model may be a Segment Anything Model (SAM).

FIG. 4(A) schematically shows a schematic diagram of an original image according to embodiments of the present disclosure. FIG. 4(B) schematically show a schematic diagram of a marked original image according to embodiments of the present disclosure. FIG. 4(C) schematically shows a schematic diagram of a foreground image according to embodiments of the present disclosure.

As shown in FIG. 4(A), the original image may include a foreground region 401 and a background region 402.

According embodiments of the present disclosure, after the original image is marked by the user at the client, a marked original image as shown in FIG. 4(B) may be obtained in response to a marking operation at the client. As shown in FIG. 4(B), the marked original image may include a target region 401_1 and a background region 402. The target region 401_1 in the original image may be determined according to the marked original image as shown in FIG. 4(B).

According to embodiments of the present disclosure, after FIG. 4(A) and the mask matrix corresponding to FIG. 4(B) are input into the image segmentation model, a foreground image 401_2 corresponding to the foreground region 401 in FIG. 4(A) may be obtained.

According to embodiments of the present disclosure, by inputting the original image and the pixel position corresponding to the target region into the image segmentation model to generate the foreground image, it is possible to segment the foreground image from the original image quickly and accurately.

According to embodiments of the present disclosure, generating the background image according to the target region, the original image and the target resolution includes: inputting the original image and the pixel position corresponding to the target region into the image generation model to obtain an initial background image, where a resolution of the initial background image is equal to the original resolution; down-sampling the initial background image at a first preset multiple to obtain a low-resolution background image; determining a first conversion resolution according to the target resolution, a width of the low-resolution background image and a height of the low-resolution background image; and inputting the low-resolution background image and the first conversion resolution into the image generation model to generate the background image, where a resolution of the background image is the first conversion resolution.

The image generation model may be selected according to an actual situation and is not limited here. For example, the image generation model may be a text-to-image generation model, such as an SD (stable diffusion) model.

The first preset multiple may be selected according to an actual situation and is not limited here. For example, the first preset multiple may be determined according to a generation speed and a generation effect of the image generation model desired by the user. The higher the desired generation speed, the larger the first preset multiple, and the worse a quality of the generated background image. The lower the desired generation speed, the smaller the first preset multiple, and the higher the quality of the generated background image.

According to embodiments of the present disclosure, inputting the low-resolution background image and the first conversion resolution into the image generation model to generate the background image includes: acquiring a first preset prompt word and a first preset model parameter; and inputting the low-resolution background image, the first preset prompt word, the first preset model parameter and the first conversion resolution into the image generation model to generate the background image.

According to embodiments of the present disclosure, the first preset prompt word may include a positive prompt word and a negative prompt word. The positive prompt word represents a content that is desired by the user in the background image, and the negative prompt word represents a content that is not desired by the user in the background image.

According to embodiments of the present disclosure, the first preset prompt word may be determined according to the original image input by the user at the client, a content that is desired by the user in an expanded background image, and a content that is not desired by the user in the expanded background image. That is, the first preset model parameter may be determined according to a parameter configured by the user at the client.

For example, the positive prompt word may be generated according to the original image input by the user at the client, and the negative prompt word may be generated according to the content input by the user at the client that is not desired by the user in the expanded background image.

According to embodiments of the present disclosure, the first preset prompt word is determined according to the original image input by the user at the client, the content that is desired by the user in the expanded background image and the content that is not desired by the user in the expanded background image, and a function of inputting a prompt word may be added on a client interface, so that the user may input a prompt word on the client interface. The prompt word intuitively represents an expansion requirement of the user, so that the background image that is generated after the low-resolution background image, the first preset prompt word, the first preset model parameter and the first conversion resolution are input into the image generation model is more in line with requirements of the user.

According to embodiments of the present disclosure, by means of program preset weight, it is also possible to input a preset weight together with the low-resolution background image, the first preset prompt word, the first preset model parameter and the first conversion resolution into the image generation model to generate the background image. For example, a weight corresponding to a prompt word contained in the content input by the user may be set to 0.6, and a weight of a prompt word generated according to the original image may be set to 0.4.

The first conversion resolution has the same aspect ratio as the target image, and the first conversion resolution is less than the target resolution.

According to embodiments of the present disclosure, inputting the original image and the pixel position corresponding to the target region into the image generation model to obtain the initial background image includes: inputting the original image and the mask matrix into the image generation model to obtain the initial background image. The initial background image does not contain the target element.

FIG. 4(D) schematically shows a schematic diagram of an initial background image according to embodiments of the present disclosure. FIG. 4(E) schematically shows a schematic diagram of a background image according to embodiments of the present disclosure. FIG. 4(F) schematically shows a schematic diagram of a rearranged image according to embodiments of the present disclosure.

After the image generation model is configured to an inward expansion generation mode, and the original image in FIG. 4(A), the mask matrix corresponding to FIG. 4(B) and the first preset model parameter are inputted into the image generation model, an initial background image 402_1 in FIG. 4(D) may be obtained. In the inward expansion generation mode, the image generation model may generate an inward expansion content on the basis of the background region in the original image. The image generation model may determine the target region 401_1 and the background region 402 from the original image according to the mask matrix, generate the inward expansion content on the basis of the background region 402, and fill the inward expansion content into the target region 401_1 of the original image, so as to obtain the initial background image 402_1 in FIG. 4(D).

The initial background image 402_1 is down-sampled at the first preset multiple to obtain a low-resolution background image, and a first conversion resolution is determined according to the target resolution, the width of the low-resolution background image and the height of the low-resolution background image. After that, the generation model may be configured to an outward expansion generation mode, and the low-resolution background image, the first preset prompt word, the first preset model parameter and the first conversion resolution may be input into the image generation model to generate a background image 402_2 in FIG. 4(E). In the outward expansion generation mode, the image generation model may generate an outward expansion content on the basis of the low-resolution background image, and stitch the outward expansion content and the low-resolution background image to obtain the background image 402_2 having the first conversion resolution.

The background image 402_2 in FIG. 4(E) and the foreground image 401_2 in FIG. 4(C) may be stitched together to obtain a rearranged image in FIG. 4(F). The rearranged image in FIG. 4(F) includes the foreground image 401_2 and an adjusted background image 402_3 that is obtained by down-sampling the background image in FIG. 4(E). Subsequently, the resolution of the rearranged image in FIG. 4(F) may be adjusted to the target resolution using the image super-resolution model, so as to obtain the target image.

According to embodiments of the present disclosure, by inputting the original image and the pixel position corresponding to the target region into the image generation model to obtain the initial background image, it is possible to obtain an initial background image that has the same resolution as the original resolution and that does not contain the target element. The initial background image is then down-sampled at the first preset multiple to obtain a low-resolution background image; and the first conversion resolution is determined according to the target resolution, the width of the low-resolution background image and the height of the low-resolution background image. The low-resolution background image has a low resolution, and the first conversion resolution is less than the target resolution. Therefore, in a subsequent process of inputting the low-resolution background image and the first conversion resolution into the image generation model to generate a background image of which the resolution is the first conversion resolution, an efficiency of the image generation model processing the low-resolution background image may be improved, and the background image may be generated quickly.

According to embodiments of the present disclosure, determining the first conversion resolution according to the target resolution, the width of the low-resolution background image and the height of the low-resolution background image includes: determining a second width ratio of the target pixel width to the width of the low-resolution background image; determining a second height ratio of the target pixel height to the height of the low-resolution background image; determining the height of the low-resolution background image as a height of the first conversion resolution in a case that the second height ratio is greater than or equal to the second width ratio; and determining a width of the first conversion resolution according to the height of the first conversion resolution and a ratio of the target pixel width to the target pixel height.

The second width ratio may be the ratio of the target pixel width to the width of the low-resolution background image. The second height ratio may be the ratio of the target pixel height to the height of the low-resolution background image. The width of the first conversion resolution may be obtained by multiplying the ratio of the target pixel width to the target pixel height by the height of the first conversion resolution.

For example, the second width ratio may be obtained according to Equation (9), and the second height ratio may be obtained according to Equation (10).

$$Second width ratio = \frac{{w}_{d}}{{w}_{o 1}} \qquad ( 9 )$$

$$Second height ratio = \frac{{h}_{d}}{{h}_{o 1}} \qquad ( 10 )$$

where wₒ₁ represents the width of the low-resolution background image, and hₒ₁ represents the height of the low-resolution background image.

For example, in a case of

$$\frac{{w}_{d}}{{w}_{o 1}} \geq \frac{{h}_{d}}{{h}_{o 1}} ,$$

the height of the first conversion resolution may be determined according to Equation (11), and the width of the first conversion resolution may be determined according to Equation (12).

$${h}_{o 2} = {h}_{o 1} \qquad ( 11 )$$

$${w}_{o 2} = {h}_{02} * \frac{{w}_{d}}{{h}_{d}} \qquad ( 12 )$$

where, hₒ₂ represents the height of the first conversion resolution, and wₒ₂ represents the width of the first conversion resolution.

According to embodiments of the present disclosure, in the case that the second height ratio is greater than or equal to the second width ratio, the height of the low-resolution background image is determined as the height of the first conversion resolution, and the width of the first conversion resolution is determined according to the height of the first conversion resolution and the ratio of the target pixel width to the target pixel height, so that a first conversion resolution having a low resolution and having the same aspect ratio as the target resolution may be determined on the basis of the height of the low-resolution background image.

According to embodiments of the present disclosure, determining the first conversion resolution according to the target resolution, the width of the low-resolution background image and the height of the low-resolution background image further includes: in a case that the second height ratio is less than the second width ratio, determining the width of the low-resolution background image as the width of the first conversion resolution; and determining the height of the first conversion resolution according to the width of the first conversion resolution and a ratio of the target pixel height to the target pixel width.

According to embodiments of the present disclosure, the height of the first conversion resolution may be obtained by multiplying the ratio of the target pixel height to the target pixel width by the width of the first conversion resolution.

For example, in a case of

$$\frac{{w}_{d}}{{w}_{o 1}} < \frac{{h}_{d}}{{h}_{o 1}} ,$$

the width of the first conversion resolution may be determined according to Equation (13), and the height of the first conversion resolution may be determined according to Equation (14).

$${w}_{02} = {w}_{01} \qquad ( 13 )$$

$${h}_{o 2} = {w}_{02} * \frac{{h}_{d}}{{w}_{d}} \qquad ( 14 )$$

According to embodiments of the present disclosure, in the case that the second height ratio is less than the second width ratio, the width of the low-resolution background image is determined as the width of the first conversion resolution, and the height of the first conversion resolution is determined according to the width of the first conversion resolution and the ratio of the target pixel height to the target pixel width, so that a first conversion resolution having a low resolution and having the same aspect ratio as the target resolution may be determined on the basis of the width of the low-resolution background image.

According to embodiments of the present disclosure, in a case that the amount of data of the filling content needs to be generated is small, for example, in a case that the aspect ratio is expanded from 9:16 to 12:16, it is possible to directly perform a background expansion on the original image by using the image generation model.

According to embodiments of the present disclosure, generating the target image according to the original image, the original resolution and the target resolution includes: down-sampling the original image at a second preset multiple to obtain a low-resolution image; determining a second conversion resolution according to the target resolution, a width of the low-resolution image and a height of the low-resolution image; inputting the down-sampled original image and the second conversion resolution into an image generation model to generate an intermediate conversion image, where a resolution of the intermediate conversion image is the second conversion resolution; and adjusting the resolution of the intermediate conversion image according to the target resolution and the intermediate conversion image, so as to generate the target image.

According to embodiments of the present disclosure, it is also possible to firstly determine a relationship between the difference value and the preset threshold, and then directly perform a background expansion on the original image to generate the target image.

For example, generating the target image according to the original image, the original resolution and the target resolution may include: in the case that the difference value is greater than or equal to the preset threshold, down-sampling the original image at a second preset multiple to obtain a low-resolution image; determining a second conversion resolution according to the target resolution, a width of the low-resolution image and a height of the low-resolution image; inputting the down-sampled original image and the second conversion resolution into an image generation model to generate an intermediate conversion image, where a resolution of the intermediate conversion image is the second conversion resolution; and adjusting the resolution of the intermediate conversion image according to the target resolution and the intermediate conversion image, so as to generate the target image. In the case that the difference value is greater than or equal to the preset threshold, it means that the original resolution of the original image and the target resolution have a small difference in the aspect ratio, and a small amount of filling content needs to be regenerated.

The second preset multiple may be selected according to an actual situation and is not limited here. For example, the second preset multiple may be determined according to a generation speed and a generation effect of the image generation model desired by the user. The higher the desired generation speed, the larger the second preset multiple, and the worse the quality of the generated target image. The lower the desired generation speed, the smaller the second preset multiple, and the higher the quality of the generated target image.

The second conversion resolution may have the same aspect ratio as the target resolution, and the second conversion resolution is less than the target resolution.

According to embodiments of the present disclosure, inputting the down-sampled original image and the second conversion resolution into the image generation model to generate the intermediate conversion image includes: acquiring a second preset prompt word and a second preset model parameter; and inputting the down-sampled original image, the second preset prompt word, the second preset model parameter and the second conversion resolution into the image generation model to generate the intermediate conversion image.

According to embodiments of the present disclosure, the second preset prompt word may include a positive prompt word and a negative prompt word. The positive prompt word represents a content that is desired by the user in the target image, and the negative prompt word represents a content that is not desired by the user in the target image.

According to embodiments of the present disclosure, a method of generating the second preset prompt word is similar to the method of generating the first preset prompt word, and the same effect may be achieved. A method of generating the second preset model parameter is similar to the method of generating the first preset model parameter, and the same effect may be achieved.

According to embodiments of the present disclosure, by means of program preset weight, it is also possible to input a preset weight together with the down-sampled original image, the second preset prompt word, the second preset model parameter and the second conversion resolution into the image generation model to generate the intermediate conversion image. For example, a weight corresponding to a prompt word contained in the content input by the user may be set to 0.6, and a weight of a prompt word generated according to the original image may be set to 0.4.

According to embodiments of the present disclosure, the generation model may be configured to an outward expansion generation mode first. Then, the down-sampled original image, the second preset prompt word, the second preset model parameter and the second conversion resolution may be input into the image generation model. The generation model may generate an outward expansion content on the basis of the down-sampled original image, and stitch the outward expansion content with the down-sampled original image to obtain an intermediate conversion image of which a resolution is the second conversion resolution.

It is possible to generate one or two or more intermediate conversion images. In a case that two or more intermediate conversion images are generated, it is possible to display a plurality of intermediate conversion images at a client, obtain an intermediate conversion image selected at the client in response to a selection operation at the client, and then perform subsequent operations of stitching and resolution adjustment on the intermediate conversion image selected at the client, so as to achieve a deeper interaction with the user and avoid the user waiting for too long to have a poor experience in a process of generating the target image. Therefore, such an interaction design may further improve the user satisfaction.

According to embodiments of the present disclosure, it is possible to input the target resolution and the intermediate conversion image into the image super-resolution model, and adjust the resolution of the intermediate conversion image to the target resolution by using the image super-resolution model, so as to obtain the target image.

According to embodiments of the present disclosure, the target image is obtained by adjusting the resolution of the intermediate conversion image to the target resolution using the image super-resolution model, so that a super-resolution target image close to the original image and having high contrast and high clarity may be obtained simply and quickly.

According to embodiments of the present disclosure, in the case that the difference value is greater than or equal to the preset threshold, it is required to generate a small amount of filling content when the original image is expanded to the target resolution. Therefore, it is possible to directly down-sample the original image at the second preset multiple on the basis of the original image to obtain a low-resolution image, and determine a second conversion resolution according to the target resolution, the width of the low-resolution image and the height of the low-resolution image. The low-resolution image has a low resolution, and the second conversion resolution is less than the target resolution. Therefore, in a subsequent process of inputting the down-sampled original image and the second conversion resolution into the image generation model to generate the intermediate conversion image of which the resolution is the second conversion resolution, an efficiency of the image generation model processing the low-resolution image may be improved, and the intermediate conversion image may be generated quickly. Then, the resolution of the intermediate conversion image may be adjusted according to the target resolution and the intermediate conversion image to generate the target image having the target resolution, so that a target image having high contrast and high clarity may be obtained.

According to embodiments of the present disclosure, determining the second conversion resolution according to the target resolution, the width of the low-resolution image and the height of the low-resolution image includes: determining a third width ratio of the target pixel width to the width of the low-resolution image; determining a third height ratio of the target pixel height to the height of the low-resolution image; determining the height of the low-resolution image as a height of the second conversion resolution in a case that the third height ratio is greater than or equal to the third width ratio; and determining a width of the second conversion resolution according to the height of the second conversion resolution and a ratio of the target pixel width to the target pixel height.

According to embodiments of the present disclosure, the third width ratio may be the ratio of the target pixel width to the width of the lower-resolution image. The third height ratio may be the ratio of the target pixel height to the height of the lower-resolution image. The width of the second conversion resolution may be obtained by multiplying the ratio of the target pixel width to the target pixel height by the height of the second conversion resolution.

For example, the third width ratio may be obtained according to Equation (15), and the third height ratio may be obtained according to Equation (16).

$$Third width ratio = \frac{{w}_{d}}{{w}_{o 3}} \qquad ( 15 )$$

$$Third height ratio = \frac{{h}_{d}}{{h}_{o 3}} \qquad ( 16 )$$

where wₒ₃ represents the width of the low-resolution image, and hₒ₃ represents the height of low-resolution image.

For example, in a case of

$$\frac{{w}_{d}}{{w}_{o 3}} \geq \frac{{h}_{d}}{{h}_{o 3}} ,$$

the height of the second conversion resolution may be determined according to Equation (17), and the width of the second conversion resolution may be determined according to Equation (18).

$${h}_{o 4} = {h}_{o 3} \qquad ( 17 )$$

$${w}_{o 4} = {h}_{04} * \frac{{w}_{d}}{{h}_{d}} \qquad ( 18 )$$

where hₒ₄ represents the height of the second conversion resolution, and wₒ₄ represents the width of the second conversion resolution.

According to embodiments of the present disclosure, in the case that the third height ratio is greater than or equal to the third width ratio, the height of the low-resolution image is determined as the height of the second conversion resolution, and the width of the second conversion resolution is determined according to the height of the second conversion resolution and the ratio of the target pixel width to the target pixel height, so that a second conversion resolution having a low resolution and having the same aspect ratio as the target resolution may be determined on the basis of the height of the low-resolution image.

According to embodiments of the present disclosure, determining the second conversion resolution according to the target resolution, the width of the low-resolution image and the height of the low-resolution image further includes: in a case that the third height ratio is less than the third width ratio, determining the width of the low-resolution image as the width of the second conversion resolution; and determining the height of the second conversion resolution according to the width of the second conversion resolution and a ratio of the target pixel height to the target pixel width.

According to embodiments of the present disclosure, the height of the second conversion resolution may be obtained by multiplying the ratio of the target pixel height to the target pixel width by the width of the second conversion resolution.

For example, in a case of

$$\frac{{w}_{d}}{{w}_{o 3}} < \frac{{h}_{d}}{{h}_{o 3}} ,$$

the width of the second conversion resolution

may be determined according to Equation (19), and the height of the second conversion resolution may be determined according to Equation (20).

$${w}_{04} = {w}_{03} \qquad ( 19 )$$

$${h}_{o 4} = {w}_{04} * \frac{{h}_{d}}{{w}_{d}} \qquad ( 20 )$$

According to embodiments of the present disclosure, in the case that the third height ratio is less than the third width ratio, the width of the low-resolution image is determined as the width of the second conversion resolution, and the height of the second conversion resolution is determined according to the width of the second conversion resolution and the ratio of the target pixel height to the target pixel width, so that a second conversion resolution having a low resolution and having the same aspect ratio as the target resolution may be determined on the basis of the width of the low-resolution image.

FIG. 5(A) schematically shows a schematic diagram of a display apparatus according to embodiments of the present disclosure. FIG. 5(B) schematically shows a schematic diagram of directly displaying an original image on a display apparatus according to embodiments of the present disclosure. FIG. 5(C) schematically shows a schematic diagram of displaying on a display apparatus a target image that is obtained according to the image display method provided in embodiments of the present disclosure in a case that a difference value is greater than or equal to a predetermine threshold.

As shown in FIG. 5(A), the display apparatus includes a display screen 501, a display screen 502, a display screen 503 and a display screen 504. The display screen 502 is located on a right side of the display screen 501 and on an upper side of the display screen 504. The display screen 503 is located on a lower side the display screen 501 and on a left side of the display screen 504.

As shown in FIG. 5(B), in a case that the original image is directly displayed on the display apparatus as shown in FIG. 5(A), the original image is displayed in a middle region of the display apparatus, and black edges are displayed in a display region 505 and a display region 506 of the display apparatus, resulting in a poor visual experience.

As shown in FIG. 5(C), in a case that the difference value is greater than or equal to the preset threshold, the target image that is obtained by processing the original image in FIG. 5(B) according to the image display method provided in embodiments of the present disclosure may be displayed in full screen on the display apparatus shown in FIG. 5(A), the black edges are eliminated and the contrast and clarity of the display are improved, so that an optimal display effect is achieved. Further, as shown in FIG. 5(C), in the case that the difference value is greater than or equal to the preset threshold, in a process of obtaining the target image according to the image display method provided in embodiments of the present disclosure, an expansion is performed using the image display method provided in embodiments of the present disclosure to obtain the target image displayed on the display screen 501 and the display screen 502.

FIG. 6(A) schematically shows a schematic diagram of displaying on a display apparatus a target image that is obtained according to the image display method provided in embodiments of the present disclosure in a case that a difference value is greater than or equal to a predetermine threshold. FIG. 6(B) schematically shows a schematic diagram of a locally-enlarged original image and a locally-enlarged target image according to embodiments of the present disclosure.

As shown in FIG. 6(A), in the case that the difference value is greater than or equal to the preset threshold, the target image obtained according to the image display method provided in embodiments of the present disclosure may be displayed in full screen on the display apparatus, and the black edges are eliminated. After the target image displayed in the display region 601 in FIG. 6(A) is locally enlarged, an image 601_2 shown in FIG. 6(B) is obtained. After a portion of the original image corresponding to the target image displayed in the display region 601 is locally enlarged, an image 601_1 shown in FIG. 6(B) is obtained.

As the target image displayed in the display region 601 in FIG. 6(A) is obtained by a super-resolution enhancement using the image super-resolution model, it is shown in FIG. 6(B) that the image 601_2 has higher contrast and clarity than the image 601_1, which indicates that a target image with high contrast and high clarity may be obtained after the original image is processed using the image display method provided in embodiments of the present disclosure, and a good visual experience may be provided for the user.

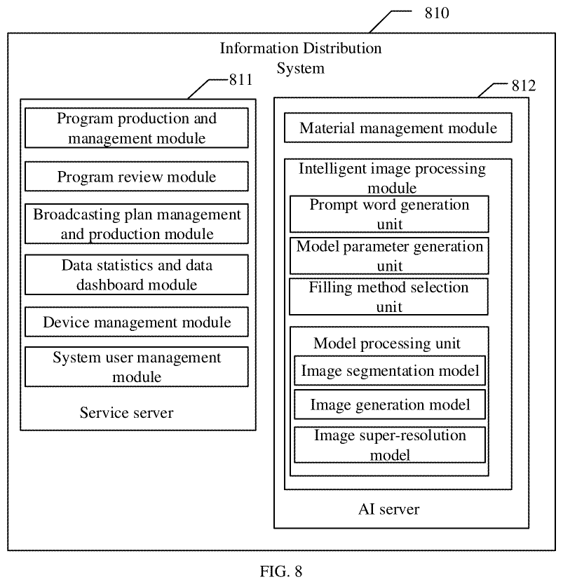

FIG. 7(A) schematically shows a schematic diagram of an original image according to embodiments of the present disclosure. FIG. 7(B) schematically shows a schematic diagram of a target image that is obtained according to the image display method provided in embodiments of the present disclosure in a case that a difference value is greater than or equal to a preset threshold. FIG. 7(C) schematically shows a schematic diagram of an original image according to embodiments of the present disclosure. FIG. 7(D) schematically shows a schematic diagram of a target image that is obtained according to the image display method provided in embodiments of the present disclosure in a case that a difference value is greater than or equal to a preset threshold. FIG. 7(E) schematically shows a schematic diagram of an original image according to embodiments of the present disclosure. FIG. 7(F) schematically shows a schematic diagram of a target image that is obtained according to the image display method provided in embodiments of the present disclosure in a case that a difference value is greater than or equal to a preset threshold. FIG. 7(G) schematically shows a schematic diagram of an original image according to embodiments of the present disclosure. FIG. 7(H) schematically shows a schematic diagram of a target image that is obtained according to the image display method provided in embodiments of the present disclosure in a case that a difference value is greater than or equal to a preset threshold

According to embodiments of the present disclosure, in the case that the difference value is greater than or equal to the preset threshold, the original image in FIG. 7(A) may be processed according to the image display method provided in embodiments of the present disclosure to obtain the target image shown in FIG. 7(B). As shown in FIG. 7(B), the image display method provided in embodiments of the present disclosure is mainly used to perform a background fill on a portion of the target image corresponding to the display region 701 and the display region 702 of the display apparatus.

According to embodiments of the present disclosure, in the case that the difference value is greater than or equal to the preset threshold, the original image in FIG. 7(C) may be processed according to the image display method provided in embodiments of the present disclosure to obtain the target image shown in FIG. 7(D). As shown in FIG. 7(D), the image display method provided in embodiments of the present disclosure is mainly used to perform a background fill on a portion of the target image corresponding to the display region 703 and the display region 704 of the display apparatus.

According to embodiments of the present disclosure, in the case that the difference value is greater than or equal to the preset threshold, the original image in FIG. 7(E) may be processed according to the image display method provided in embodiments of the present disclosure to obtain the target image shown in FIG. 7(F). As shown in FIG. 7(F), the image display method provided in embodiments of the present disclosure is mainly used to perform a background fill on a portion of the target image corresponding to the display region 705 and the display region 706 of the display apparatus.

According to embodiments of the present disclosure, in the case that the difference value is greater than or equal to the preset threshold, the original image in FIG. 7(G) may be processed according to the image display method provided in embodiments of the present disclosure to obtain the target image shown in FIG. 7(H). As shown in FIG. 7(H), the image display method provided in embodiments of the present disclosure is mainly used to perform a background fill on a portion of the target image corresponding to the display region 707 and the display region 708 of the display apparatus.

As shown in FIG. 7(A) to FIG. 7(H), for different application scenarios, the original images have different contents, the original resolutions of the original images have different aspect ratios, and the target resolutions have different aspect ratios, but each difference value corresponding to the original image is greater than or equal to the preset threshold. In this case, it is possible to obtain target images with high contrast and high clarity by processing the original images using the image display method provided in embodiments of the present disclosure, which indicates that the image display method provided in embodiments of the present disclosure has a high applicability and a high practicability.

According to embodiments of the present disclosure, the image display method as shown in FIG. 3 may further include: determining a first preset model parameter, a first preset multiple, a first preset prompt word, a second preset model parameter, a second preset multiple and a second preset prompt word according to the original image and a configuration parameter from the client, where the configuration parameter is related to a generation effect and a generation speed of the image generation model.

According to embodiments of the present disclosure, the configuration parameter includes at least one selected from: a generation style, a generation speed, a generation creativity, a text description of generated content, or a target resolution; and the first preset model parameter and the second preset model parameter each include at least one selected from: a number of pixels to expand, a degree of mask blur, an image outpainting direction, a fall-off exponent, a color variation degree parameter, a sampling method, sampling steps, a denoising strength, or a classifier free guidance scale.

According to embodiments of the present disclosure, in addition to the target resolution, the configuration parameter may further include a single-screen resolution, a number of transverse devices, and a number of longitudinal devices in a case that the display apparatus includes at least one display screen. The number of transverse devices represents a number of display screens arranged transversely in the display apparatus. The number of longitudinal devices represents a number of display screens arranged longitudinally in the display apparatus.

According to embodiments of the present disclosure, in a case that the display apparatus includes one display screen, the number of pixels to expand is equal to the target resolution. In a case that the display apparatus includes at least two display screens, the number of pixels to expand is equal to a result of multiplying the number of transverse devices by the number of longitudinal devices by the single-screen resolution.

The image outpainting direction may be determined according to the number of transverse devices and the number of longitudinal devices configured by the user. For example, in a case that the number of transverse devices is greater than or equal to 2, it may be determined that the image outpainting direction includes left-right transverse outpainting. In a case that the number of longitudinal devices is greater than or equal to 2, it may be determined that the image outpainting direction includes up-down longitudinal outpainting. The image outpainting direction may also be determined according to the original resolution of the original image and the target resolution, where the image outpainting direction includes left-right transverse outpainting and up-down longitudinal outpainting.

The smaller a value of the fall-off exponent, the higher a richness of the generated target image. The color variation degree parameter represents a parameter for adjusting a color variation degree. The larger a value of the color variation degree parameter, the richer a variation degree. The more the sampling steps, the higher the quality of the generated target image, but the slower the generation speed. The sampling steps may be determined according to the generation speed and the generation creativity configured by the user. The denoising strength represents a degree of an influence of the original image on the target image. The smaller a value of the denoising strength, the greater the influence. The higher the classifier free guidance scale, the higher a relevance degree between the content in the generated target image and the prompt word, and the lower the creativity of the generated target image. The classifier free guidance scale may be determined according to the generation creativity configured by the user.

In the first preset model parameter and the second preset model parameter, the parameters such as the number of pixels to expand, the image outpainting direction, the sampling steps, the classifier free guidance scale, etc. may be determined by user-configured parameters, and other parameters may be determined by system preset configuration.

For commonly-used application scenarios such as landscape, character, architecture, etc., it is possible to select a plurality of representative original images for each scenario to perform a model parameter test, so as to select system preset configurations other than the configuration parameters configured by the user on an interaction interface. Each application scenario finally corresponds to a configuration parameter file. When a style corresponding to a specified application scenario is selected by the user at the client, the corresponding model configuration parameters are loaded and input into the model.

According to embodiments of the present disclosure, the first preset prompt word and the second preset prompt word each include a positive prompt word and a negative prompt word.

According to embodiments of the present disclosure, a method of generating a positive prompt word includes the following steps. 1) The original image is input into a CLIP model (Contrastive Language-Image Pre-Training, a contrastive-learning multimodal model) to identify a text description of the original image, that is, an image is converted to a text. For example, if an original image containing a dog is input, the CLIP model may output “A photo of a dog”. 2) A preset positive prompt word is acquired according to the generation style configured by the user. For example, the generation style may be a poster background image generation style which is commonly used in business. For example, if three styles including “landscape, character, architecture” are preset, the prompt words corresponding to the three styles may include:

landscape: “best quality, ultra high res, poster, projected inset, gradient, gradient background, oekaki, vector trace, masterpiece, illustration, widescreen”, character: “best quality, ultra high res, (photorealistic: 1.4), photo_\(medium\), realistic, 8k uhd, dslr, soft lighting, high quality, film grain”, architecture: “dynamic posture, 8k uhd, dslr, soft lighting, high quality, film grain”, etc. 3) The image-to-text description prompt word generated by CLIP in step 1) is combined with a general style description prompt word in step 2) to obtain a positive prompt word of the model. The model performs a background expansion of image content and style according to the positive prompt word, so as to keep consistent content and style with the original image.

According to embodiments of the present disclosure, a method of generating a negative prompt word includes: acquiring a preset negative prompt word corresponding to a content that is avoided in the target image according to the text description of generated content configured by the user. For example, if a text content, a watermark, etc. are not desired, the preset negative prompt word may include: “lowres, bad anatomy, bad hands, text, error, missing fingers, extra digit, fewer digits, cropped, worst quality, low quality, normal quality, jpeg artifacts, signature, watermark, username, blurry, parody”.

FIG. 8 schematically shows a system architecture diagram for an image display method according to embodiments of the present disclosure.

As shown in FIG. 8, an information distribution system 810 includes a service server 811 and an AI server 812. The service server 811 and the AI server 812 in the information distribution system 810 may replace the server 205 in FIG. 2 to be applied in the application scenario in FIG. 2.

The service server 811 includes a program production and management module, a program review module, a broadcasting plan management and production module, a data statistics and data dashboard module, a device management module and a system user management module. The service server 811 is used to perform a programming on the original image or the target image, such as a poster, an advertisement or other broadcasting materials, in response to a programming operation at the client, and then send to the information distribution box.

The AI server 812 includes a material management module and an intelligent image processing module. The material management module is used to store the original image uploaded from the client and the target image generated according to the image display method provided in embodiments of the present disclosure. The intelligent image processing module is used to perform the image display method provided in embodiments of the present disclosure. The intelligent image processing module includes a prompt word generation unit, a model parameter generation unit, a filling method selection unit and a model processing unit. The model processing unit includes an image segmentation model, an image generation model, and an image super-resolution model. The image segmentation model is used to segment the original image to generate a foreground image. The image generation model is used to perform an image expanded generation on the original image input from the client. The image super-resolution model is used to further improve a display quality and a resolution of an image generated by the image generation model.

For example, the user is allowed to send a produced original image to the material management module in the AI server 812 through the information distribution box. The material management module has no restriction on the resolution and the aspect ratio of the original image. The AI server 812 may display a functional interface for AI image generation at the client in response to a user request for processing an original image of poster.

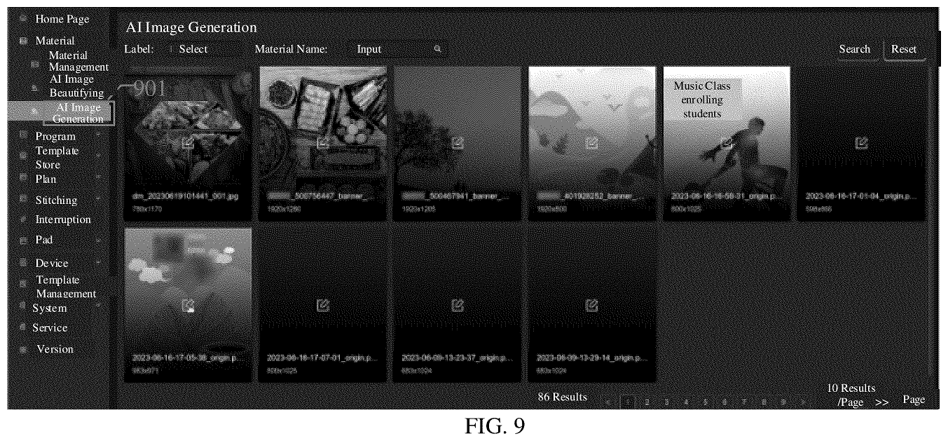

FIG. 9 schematically shows a schematic diagram of a functional interface for AI image generation according to embodiments of the present disclosure.

As shown in FIG. 9, the functional interface for AI image generation includes a select box of AI image generation 901. In response to the user clicking on the select box of AI image generation 901, original images sent to the material management module by the user may be displayed at the client. In response to a user click operation on an original image, the original image is determined as the original image to be processed by the image display method provided in embodiments of the present disclosure. At the same time, the AI server 812 may generate a functional interface for intelligent image filling, which is sent to the client for display through the information distribution box.

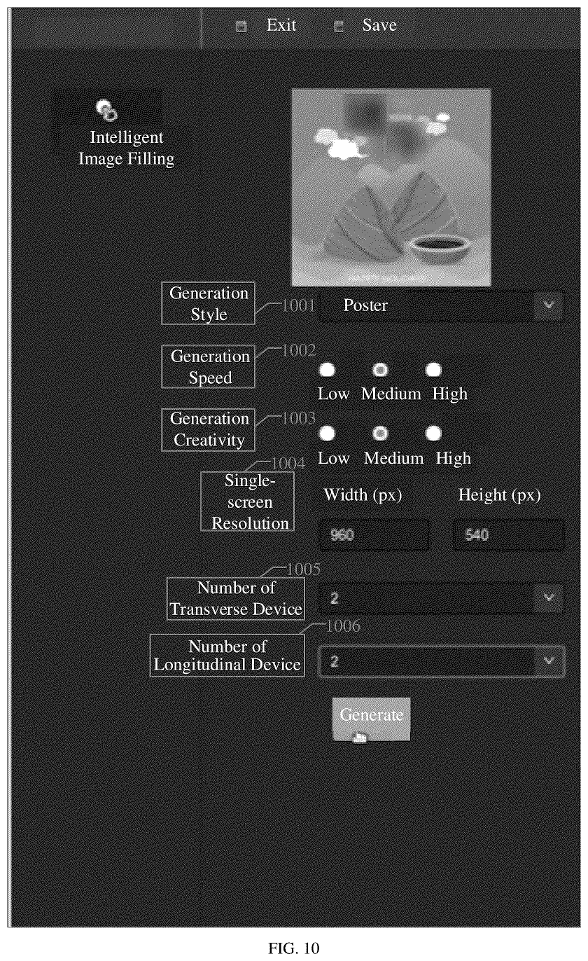

FIG. 10 schematically shows a schematic diagram of a functional interface for intelligent image filling according to embodiments of the present disclosure.

As shown in FIG. 10, the original image selected by the user is displayed on the functional interface for intelligent image filling. The user is allowed to configure parameters including a generation style 1001, a generation speed 1002, a generation creativity 1003, a single-screen resolution 1004, a number of transverse devices 1005, and a number of longitudinal devices 1006 on the functional interface for intelligent image filling.

For example, in FIG. 10, the generation style 1001 may be selected from poster, milk tea, coconut tree, sea, etc. The generation speed 1002 may be selected from low, medium, or high. The generation creativity 1003 may be selected from low, medium, or high. The single-screen resolution 1004 may be set to a width of 960 px and a height of 540 px. The number of transverse devices 1005 may be set to 2. The number of longitudinal devices 1006 may be set to 2.

According to embodiments of the present disclosure, the generation style 1001 configured by the user may be determined as the positive prompt word.

When the display apparatus is a single screen, the number of transverse devices 1005 and the number of longitudinal devices 1006 are set to 1 by default.

According to embodiments of the present disclosure, for the configuration of the generation speed 1002, the lower the generation speed 1002, the higher the quality and the richer the details of the target image generated by the model; and the higher the generation speed 1002, the lower the quality and the coarser the details of the generated image. For the configuration of the generation creativity 1003, the lower the generation creativity 1003, the simpler a background content generated by the model; and the higher the generation creativity 1003, the richer the background content generated by the model. For the configuration of the generation style 1001, it is possible to select a preset generation style in the information distribution system 810, such as poster, landscape, character, etc.

According to embodiments of the present disclosure, a parameter of the text description of generated content may be further included in FIG. 10, so that the AI server may determine the content that is desired by the user in the target image and the content that is not desired by the user in the target image according to the text description of generated content, and determine the positive prompt word and the negative prompt word according to the text description of generated content.

In response to a user click operation on a generate key, the client may send the user-configured parameters to the AI server 812 through the information distribution box. Then, the AI server 812 may process the original image according to the image display method provided in embodiments of the present disclosure based on the original image and the configuration parameters related to the generation effect and the generation speed of the image generation model from the client, so as to obtain the target image.

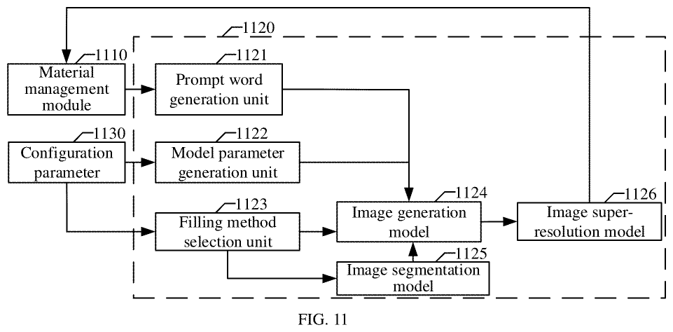

FIG. 11 schematically shows a flowchart of an image display method according to other embodiments of the present disclosure.

In FIG. 11, a material management module 1110 may send a stored original image, which is obtained from the client, to an intelligent image processing module 1120. The intelligent image processing module 1120 includes a prompt word generation unit 1121, a model parameter generation unit 1122, a filling method selection unit 1123, an image generation model 1124, an image segmentation model 1125 and an image super-resolution model 1126. The prompt word generation unit 1121 may determine a positive prompt word in the first preset prompt word and the second preset prompt word according to the original image.

The intelligent image processing module 1120 may receive a configuration parameter 1130 related to the generation effect and the generation speed of the image generation model from the client. The intelligent image processing module 1120 may determine a positive prompt word and a negative prompt word in the first preset prompt word, a positive prompt word and a negative prompt word in the second preset prompt word, a first preset multiple, and a second preset multiple according to the configuration parameter 1130, and send the positive prompt word and the negative prompt word in the first preset prompt word, the positive prompt word and the negative prompt word in the second preset prompt word, the first preset multiple and the second preset multiple to the image generation model 1124.

The model parameter generation unit 1122 may determine a first preset model parameter and a second preset model parameter according to the configuration parameter 1130, and send the first preset model parameter and the second preset model parameter to the image generation model 1124.

The filling method selection unit 1123 may acquire an original resolution and a target resolution according to the configuration parameter 1130, and determine a difference value according to the original resolution and the target resolution. In a case that the difference value is greater than or equal to a preset threshold, the filling method selection unit 1123 may determine to directly expand the original image using the image generation model 1124, then adjust a resolution of an image expanded by the image generation model 1124 by using the image super-resolution model 1126 to generate a target image, and store the target image in the material management module 1110.

In a case that the difference value is less than the preset threshold, the filling method selection unit 1123 may determine to firstly segment the original image using the image segmentation model 1125 to obtain a foreground image, and then expand a background of the original image using the image generation model 1124 to obtain a background image. The intelligent image processing module 1120 may stitch the background image and the foreground image to obtain a rearranged image, adjust a resolution of the rearranged image using the image super-resolution model 1126 to generate a target image, and store the target image in the material management module 1110.

As shown in FIG. 8 to FIG. 11, according to the image display method provided in embodiments of the present disclosure, the difference value determined according to the original resolution and the target resolution may represent a difference in the aspect ratio between the original resolution and the target resolution. In different cases of the difference value, different strategies may be used to expand the original image to the target resolution, so that the target image sent to the display apparatus may be displayed in full screen on the display apparatus without problems of stretching and distortion or unclear display, thus providing a good visual experience for the user.

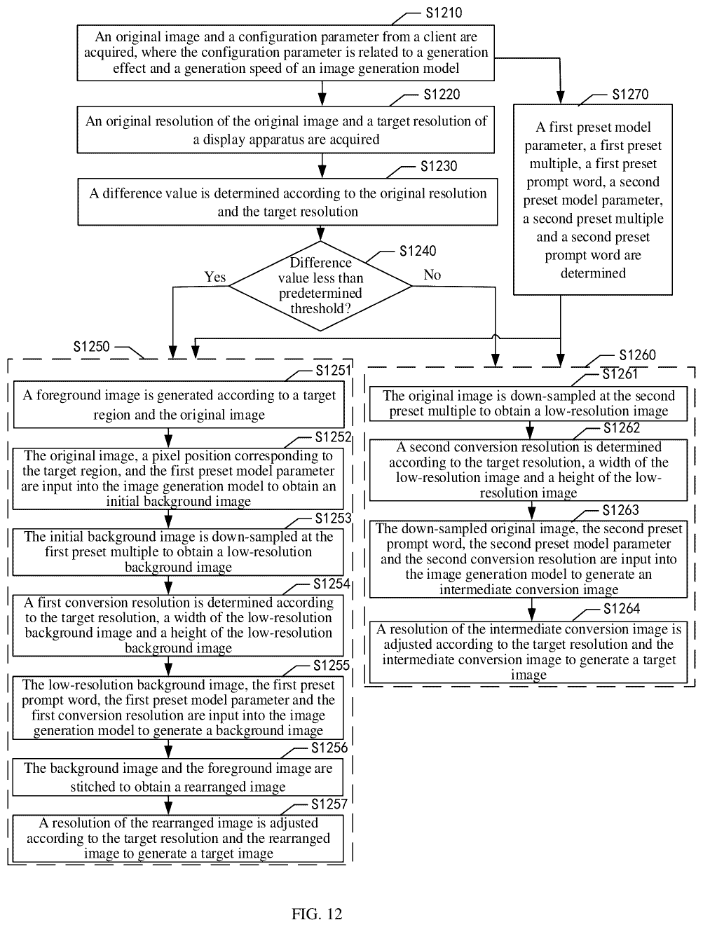

FIG. 12 schematically shows a flowchart of an image display method according to still other embodiments of the present disclosure.

According to embodiments of the present disclosure, a specific implementation method of the modules and the units in FIG. 11 are shown in FIG. 12.

As shown in FIG. 12, the image display method in such embodiments includes operation S1210 to operation S1270, where operation S1250 includes sub-operation S1251 to sub-operation S1257, and operation S1260 includes sub-operation S1261 to sub-operation S1264.

In operation S1210, an original image and a configuration parameter from a client are acquired, where the configuration parameter is related to a generation effect and a generation speed of an image generation model.

Then, according to the original image and the configuration parameter related to the generation effect and the generation speed of the image generation model from the client, an original resolution of the original image and a target resolution of a display apparatus are acquired in operation S1220, and a first preset model parameter, a first preset multiple, a first preset prompt word, a second preset model parameter, a second preset multiple and a second preset prompt word are determined in operation S1270.

In operation S1230, a difference value is determined according to the original resolution and the target resolution.

In operation S1240, it is determined whether the difference value is less than a preset threshold. If yes, operation S1250 is executed. If no, operation S1260 is executed.

When operation S1250 is executed, in sub-operation S1251, a foreground image is generated according to a target region and the original image; in sub-operation S1252, the original image, a pixel position corresponding to the target region, and the first preset model parameter are input into the image generation model to obtain an initial background image; in sub-operation S1253, the initial background image is down-sampled at the first preset multiple to obtain a low-resolution background image; in sub-operation S1254, a first conversion resolution is determined according to the target resolution, a width of the low-resolution background image and a height of the low-resolution background image; in sub-operation S1255, the low-resolution background image, the first preset prompt word, the first preset model parameter and the first conversion resolution are input into the image generation model to generate a background image; in sub-operation S1256, the background image and the foreground image are stitched to obtain a rearranged image; in sub-operation S1257, a resolution of the rearranged image is adjusted according to the target resolution and the rearranged image to generate a target image.

When operation S1260 is executed, in sub-operation S1261, the original image is down-sampled at the second preset multiple to obtain a low-resolution image; in sub-operation S1262, a second conversion resolution is determined according to the target resolution, a width of the low-resolution image and a height of the low-resolution image; in sub-operation S1263, the down-sampled original image, the second preset prompt word, the second preset model parameter and the second conversion resolution are input into the image generation model to generate an intermediate conversion image; in sub-operation S1264, a resolution of the intermediate conversion image is adjusted according to the target resolution and the intermediate conversion image to generate a target image.

As shown in FIG. 12, according to the image display method provided in embodiments of the present disclosure, the difference value determined according to the original resolution and the target resolution may represent a difference in the aspect ratio between the original resolution and the target resolution. In different cases of the difference value, different strategies may be used to expand the original image to the target resolution, so that the target image sent to the display apparatus may be displayed in full screen on the display apparatus without problems of stretching and distortion or unclear display, thus providing a good visual experience for the user.

According to embodiments of the present disclosure, as shown in FIG. 12, different cases of the difference value between the original resolution and the target resolution reflect different product requirements. That is, in the case that the difference value is greater than or equal to the preset threshold, the product requirement is to directly expand the background of the original image, while in the case that the difference value is less than the preset threshold, the product requirement is to expand the background image and then perform a content rearrangement on the expanded background image and the foreground image.

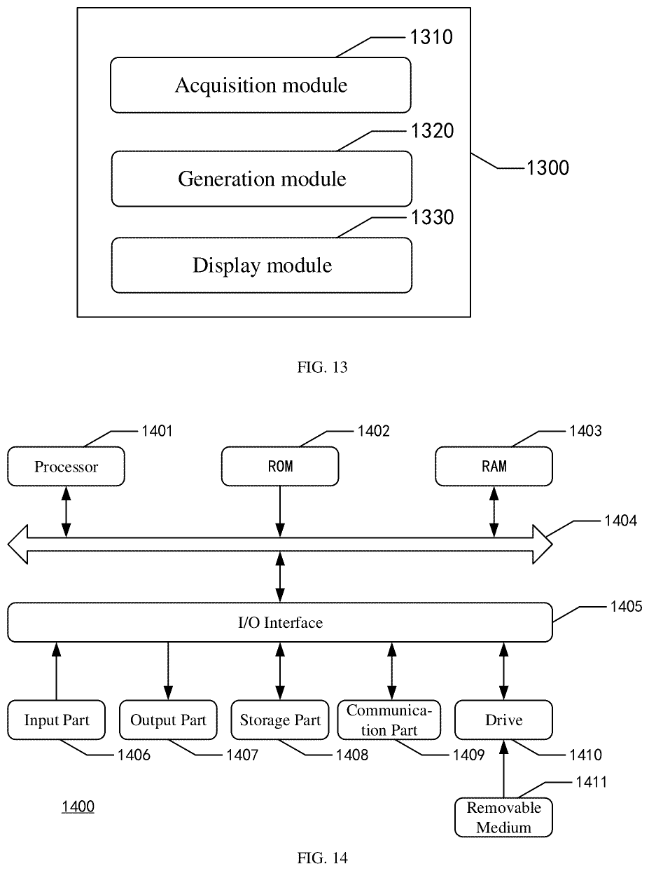

On the basis of the image display method mentioned above, the present disclosure further provides an image display apparatus. The apparatus will be described in detail below with reference to FIG. 13.

FIG. 13 schematically shows a structural block diagram of an image display apparatus according to embodiments of the present disclosure.

As shown in FIG. 13, an image display apparatus 1300 includes an acquisition module 1310, a generation module 1320, and a display module 1330.

The acquisition module 1310 is used to acquire an original resolution of an original image and a target resolution of a display apparatus. In an embodiment, the acquisition module 1310 may be used to execute operation S310 mentioned above, which will not be repeated here.

The generation module 1320 is used to generate a target image according to the original image, the original resolution and the target resolution. In an embodiment, the generation module 1320 may be used to execute operation S320 mentioned above, which will not be repeated here.

The display module 1330 is used to send the target image to the display apparatus, so that the display apparatus displays the target image. In an embodiment, the display module 1330 may be used to execute operation S330 mentioned above, which will not be repeated here.

According to embodiments of the present disclosure, any number of the acquisition module 1310, the generation module 1320 and the display module 1330 may be combined into one module for implementation, or any one of the modules may be divided into a plurality of modules. Alternatively, at least part of the functions of one or more of these modules may be combined with at least part of the functions of other modules and implemented in one module. According to embodiments of the present disclosure, at least one of the acquisition module 1310, the generation module 1320 and the display module 1330 may be implemented at least partially as a hardware circuit, such as a field programmable gate array (FPGA), a programmable logic array (PLA), a system on a chip, a system on a substrate, a system on a package, an application specific integrated circuit (ASIC), or may be implemented by hardware or firmware in any other reasonable manner of integrating or encapsulating the circuit, or may be implemented by any one of the three implementation modes of software, hardware and firmware or an appropriate combination thereof. Alternatively, at least one of the acquisition module 1310, the generation module 1320 and the display module 1330 may be at least partially implemented as a computer program module that may perform corresponding functions when executed.

FIG. 14 schematically shows a block diagram of an electronic device suitable for implementing an image display method according to embodiments of the present disclosure.

As shown in FIG. 14, an electronic device 1400 according to embodiments of the present disclosure includes a processor 401, which may execute various appropriate actions and processing according to the program stored in a read only memory (ROM) 1402 or the program loaded into a random access memory (RAM) 803 from a storage part 1408. The processor 1401 may, for example, include a general-purpose microprocessor (for example, CPU), an instruction set processor and/or a related chipset and/or a special-purpose microprocessor (for example, an application specific integrated circuit (ASIC)), and the like. The processor 1401 may further include an on-board memory for caching purposes. The processor 1401 may include a single processing unit or multiple processing units for executing different actions of the method flow according to embodiments of the present disclosure.

Various programs and data required for the operation of the device 1400 are stored in the RAM 1403. The processor 1401, the ROM 1402 and the RAM 1403 are connected to each other through a bus 1404. The processor 1401 executes various operations of the method flow according to embodiments of the present disclosure by executing the programs in the ROM 1402 and/or the RAM 1403. It should be noted that the program may also be stored in one or more memories other than the ROM 1402 and the RAM 1403. The processor 1401 may also execute various operations of the method flow according to embodiments of the present disclosure by executing the programs stored in the one or more memories.

According to embodiments of the present disclosure, the electronic device 1400 may further include an input/output (I/O) interface 1405 which is also connected to the bus 1404. The device 1400 may further include one or more of the following components connected to the I/O interface 1405: an input part 1406 including a keyboard, a mouse, etc.; an output part 1407 including a cathode ray tube (CRT), a liquid crystal display (LCD), etc. and a speaker, etc.; a storage part 1408 including a hard disk, etc.; and a communication part 1409 including a network interface card such as a LAN card, a modem, and the like. The communication part 1409 performs communication processing via a network such as the Internet. A drive 1410 is also connected to the I/O interface 1405 as required. A removable medium 1411, such as a magnetic disk, an optical disk, a magneto-optical disk, a semiconductor memory, and the like, is installed on the drive 1410 as required, so that the computer program read therefrom is installed into the storage part 1408 as needed.

The present disclosure further provides a non-transitory computer-readable storage medium, which may be included in the apparatus/device/system described in the above embodiments; or exist alone without being assembled into the apparatus/device/system. The above-mentioned computer-readable storage medium carries one or more programs that when executed, perform the methods according to embodiments of the present disclosure.

According to embodiments of the present disclosure, the computer-readable storage medium may be a non-volatile computer-readable storage medium, for example, may include but not limited to: a portable computer disk, a hard disk, a random access memory (RAM), a read-only memory (ROM), an erasable programmable read-only memory (EPROM or flash memory), a portable compact disk read-only memory (CD-ROM), an optical storage device, a magnetic storage device, or any suitable combination of the above. In the present disclosure, the computer-readable storage medium may be any tangible medium that contains or stores programs that may be used by or in combination with an instruction execution system, apparatus or device. For example, according to embodiments of the present disclosure, the computer-readable storage medium may include the above-mentioned ROM 1402 and/or RAM 1403 and/or one or more memories other than the ROM 1402 and RAM 1403.

Embodiments of the present disclosure further include a computer program product, which contains a computer program. The computer program contains program code for performing the method as shown in the flowchart. When the computer program product runs on a computer system, the program code causes the computer system to implement the image display method provided in embodiments of the present disclosure

When the computer program is executed by the processor 1401, the above-mentioned functions defined in the system/apparatus of the embodiments of the present disclosure are performed. According to embodiments of the present disclosure, the above-described systems, apparatuses, modules, units, etc. may be implemented by computer program modules.

In an embodiment, the computer program may rely on a tangible storage medium such as an optical storage device and a magnetic storage device. In another embodiment, the computer program may also be transmitted and distributed in the form of signals on a network medium, downloaded and installed through the communication part 1409, and/or installed from the removable medium 1411. The program code contained in the computer program may be transmitted by any suitable medium, including but not limited to a wireless one, a wired one, or any suitable combination of the above.

In such embodiments, the computer program may be downloaded and installed from the network through the communication part 1409, and/or installed from the removable medium 1411. When the computer program is executed by the processor 1401, the above-mentioned functions defined in the system of embodiments of the present disclosure are performed. According to embodiments of the present disclosure, the above-described systems, apparatuses, devices, modules, units, etc. may be implemented by computer program modules.

According to the embodiments of the present disclosure, the program code for executing the computer programs provided by the embodiments of the present disclosure may be written in any combination of one or more programming languages. In particular, these computing programs may be implemented using high-level procedures and/or object-oriented programming languages, and/or assembly/machine languages. Programming languages include, but are not limited to, Java, C++, Python, “C” language or similar programming languages. The program code may be completely executed on the user computing device, partially executed on the user device, partially executed on the remote computing device, or completely executed on the remote computing device or server. In a case of involving a remote computing device, the remote computing device may be connected to a user computing device through any kind of network, including a local area network (LAN) or a wide area networks (WAN), or may be connected to an external computing device (e.g., through the Internet using an Internet service provider).

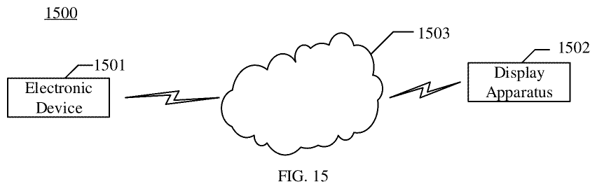

FIG. 15 schematically shows a schematic diagram of an image display device according to embodiments of the present disclosure.

As shown in FIG. 15, the image display device 1500 includes an electronic device 1501 and a display apparatus 1502. The display apparatus 1502 is used to acquire a target image from the electronic device 1501 and display the target image.

In FIG. 15, the electronic device 1501 communicates with the display apparatus 1502 through a network 1503. The network 1503 is a medium for providing a communication link between the electronic device 1501 and the display apparatus 1502. The network 1503 may include various connection types, such as wired and/or wireless communication links, or fiber optic cable, etc.

According to embodiments of the present disclosure, the electronic device 1501 may be the electronic device 1400 in FIG. 14. The display apparatus 1502 may include at least one display screen. For example, the display apparatus 1502 may be a single display screen, or may be a display screen spliced by four single display screens having the same resolution

It should be noted that the original images involved in FIG. 1 to FIG. 15 are all from a public library, which is a free public resource.

The flowcharts and block diagrams in the accompanying drawings illustrate the possible architecture, functions, and operations of the system, method, and computer program product according to various embodiments of the present disclosure. In this regard, each block in the flowcharts or block diagrams may represent a part of a module, a program segment, or a code, which part includes one or more executable instructions for implementing the specified logical function. It should be further noted that, in some alternative implementations, the functions noted in the blocks may also occur in a different order from that noted in the accompanying drawings. For example, two blocks shown in succession may actually be executed substantially in parallel, or they may sometimes be executed in a reverse order, depending on the functions involved. It should be further noted that each block in the block diagrams or flowcharts, and the combination of blocks in the block diagrams or flowcharts, may be implemented by a dedicated hardware-based system that performs the specified functions or operations, or may be implemented by a combination of dedicated hardware and computer instructions.

Those skilled in the art may understand that various embodiments of the present disclosure and/or the features described in claims may be combined in various ways, even if such combinations are not explicitly described in the present disclosure. In particular, without departing from the spirit and teachings of the present disclosure, the various embodiments of the present disclosure and/or the features described in the claims may be combined in various ways. All these combinations fall within the scope of the present disclosure.

Embodiments of the present disclosure have been described above. However, these embodiments are for illustrative purposes only, and are not intended to limit the scope of the present disclosure. Although the various embodiments have been described separately above, this does not mean that measures in the respective embodiments may not be used in combination advantageously. The scope of the present disclosure is defined by the appended claims and their equivalents. Those skilled in the art may make various substitutions and modifications without departing from the scope of the present disclosure, and these substitutions and modifications should all fall within the scope of the present disclosure.

1. An image display method, comprising:
acquiring an original resolution of an original image and a target resolution of a display apparatus;
generating a target image according to the original image, the original resolution and the target resolution; and
sending the target image to the display apparatus, so that the display apparatus displays the target image.

2. The method according to claim 1, wherein the original resolution comprises an original pixel width and an original pixel height, and the target resolution comprises a target pixel width and a target pixel height; and the generating a target image according to the original image, the original resolution and the target resolution comprises:
determining a first height ratio of the target pixel height to the original pixel height;
determining a first width ratio of the target pixel width to the original pixel width;
determining an overlapping resolution according to the first height ratio, the first width ratio, the original resolution and the target resolution;
determining a difference value according to a ratio of the overlapping resolution to the target resolution; and
generating the target image according to the difference value, the original image and the target resolution.

3. The method according to claim 2, wherein the determining an overlapping resolution according to the first height ratio, the first width ratio, the original resolution and the target resolution comprises: in a case that the first height ratio is less than or equal to the first width ratio,
determining the target pixel height as a height of the overlapping resolution; and
determining a width of the overlapping resolution according to the height of the overlapping resolution, the original pixel height and the original pixel width.

4. The method according to claim 2, wherein the determining an overlapping resolution according to the first height ratio, the first width ratio, the original resolution and the target resolution further comprises: in a case that the first height ratio is greater than the first width ratio,
determining the target pixel width as the width of the overlapping resolution; and
determining the height of the overlapping resolution according to the width of the overlapping resolution, the original pixel width and the original pixel height.

5. The method according to claim 2, wherein the generating the target image according to the difference value, the original image and the target resolution comprises: in a case that the difference value is less than a preset threshold,
determining a target region in the original image, wherein the target region contains a target element;
generating a foreground image according to the target region and the original image;
generating a background image according to the target region, the original image and the target resolution;
stitching the background image and the foreground image to obtain a rearranged image; and
adjusting a resolution of the rearranged image according to the target resolution and the rearranged image, so as to generate the target image.

6. The method according to claim 5, wherein the generating a background image according to the target region, the original image and the target resolution comprises:
inputting the original image and a pixel position corresponding to the target region into an image generation model to obtain an initial background image, wherein a resolution of the initial background image is equal to the original resolution;
down-sampling the initial background image at a first preset multiple to obtain a low-resolution background image;
determining a first conversion resolution according to the target resolution, a width of the low-resolution background image and a height of the low-resolution background image; and
inputting the low-resolution background image and the first conversion resolution into the image generation model to generate the background image, wherein a resolution of the background image is the first conversion resolution.

7. The method according to claim 6, wherein the determining a first conversion resolution according to the target resolution, a width of the low-resolution background image and a height of the low-resolution background image comprises:
determining a second width ratio of the target pixel width to the width of the low-resolution background image;
determining a second height ratio of the target pixel height to the height of the low-resolution background image;
determining the height of the low-resolution background image as a height of the first conversion resolution in a case that the second height ratio is greater than or equal to the second width ratio; and
determining a width of the first conversion resolution according to the height of the first conversion resolution and a ratio of the target pixel width to the target pixel height.

8. The method according to claim 7, wherein the determining a first conversion resolution according to the target resolution, a width of the low-resolution background image and a height of the low-resolution background image further comprises:
determining the width of the low-resolution background image as the width of the first conversion resolution in a case that the second height ratio is less than the second width ratio; and
determining the height of the first conversion resolution according to the width of the first conversion resolution and a ratio of the target pixel height to the target pixel width.

9. The method according to claim 1, wherein the generating a target image according to the original image, the original resolution and the target resolution comprises:
down-sampling the original image at a second preset multiple to obtain a low-resolution image;
determining a second conversion resolution according to the target resolution, a width of the low-resolution image and a height of the low-resolution image;
inputting the down-sampled original image and the second conversion resolution into an image generation model to generate an intermediate conversion image, wherein a resolution of the intermediate conversion image is the second conversion resolution; and
adjusting the resolution of the intermediate conversion image according to the target resolution and the intermediate conversion image, so as to generate the target image.

10. The method according to claim 9, wherein the determining a second conversion resolution according to the target resolution, a width of the low-resolution image and a height of the low-resolution image comprises:
determining a third width ratio of the target pixel width to the width of the low-resolution image;
determining a third height ratio of the target pixel height to the height of the low-resolution image;
determining the height of the low-resolution image as a height of the second conversion resolution in a case that the third height ratio is greater than or equal to the third width ratio; and
determining a width of the second conversion resolution according to the height of the second conversion resolution and a ratio of the target pixel width to the target pixel height.

11. The method according to claim 10, wherein the determining a second conversion resolution according to the target resolution, a width of the low-resolution image and a height of the low-resolution image further comprises: in a case that the third height ratio is less than the third width ratio,
determining the width of the low-resolution image as the width of the second conversion resolution; and
determining the height of the second conversion resolution according to the width of the second conversion resolution and a ratio of the target pixel height to the target pixel width.

12. The method according to claim 6, wherein the inputting the low-resolution background image and the first conversion resolution into the image generation model to generate the background image comprises:
acquiring a first preset prompt word and a first preset model parameter; and
inputting the low-resolution background image, the first preset prompt word, the first preset model parameter and the first conversion resolution into the image generation model to generate the background image.

13. The method according to claim 9, wherein the inputting the down-sampled original image and the second conversion resolution into an image generation model to generate an intermediate conversion image comprises:
acquiring a second preset prompt word and a second preset model parameter; and
inputting the down-sampled original image, the second preset prompt word, the second preset model parameter and the second conversion resolution into the image generation model to generate the intermediate conversion image.

14. The method according to claim 5, wherein the generating a foreground image according to the target region and the original image comprises:
inputting the original image and a pixel position corresponding to the target region into an image segmentation model to generate the foreground image.

15. The method according to claim 6, further comprising:
determining the first preset model parameter, the first preset multiple, the first preset prompt word, the second preset model parameter, the second preset multiple and the second preset prompt word according to the original image and a configuration parameter from a client, wherein the configuration parameter is related to a generation effect and a generation speed of the image generation model.

16. The method according to claim 15, wherein the configuration parameter comprises at least one selected from: a generation style, a generation speed, a generation creativity, a text description of generated content, or the target resolution; and
wherein the first preset model parameter and the second preset model parameter each comprise at least one selected from: a number of pixels to expand, a degree of mask blur, an image outpainting direction, a fall-off exponent, a color variation degree parameter, a sampling method, sampling steps, a denoising strength, or a classifier free guidance scale.

17. (canceled)

18. An electronic device, comprising:
one or more processors; and
a storage device configured to store one or more programs, wherein the one or more programs are configured to, when executed by the one or more processors, cause the one or more processors to perform the method of claim 1.

19. An image display device, comprising:
the electronic device according to claim 18; and
a display apparatus configured to acquire a target image from the electronic device and display the target image.

20. A non-transitory computer-readable storage medium storing executable instructions thereon, wherein the instructions are configured to, when executed by a processor, cause the processor to perform the method of claim 1.

21. (canceled)

22. The method according to claim 10, further comprising:
determining the first preset model parameter, the first preset multiple, the first preset prompt word, the second preset model parameter, the second preset multiple and the second preset prompt word according to the original image and a configuration parameter from a client, wherein the configuration parameter is related to a generation effect and a generation speed of the image generation model.
